(19) United States
(12) Patent Application Publication
(10) Pub. No.: US 2026/0203554 A1
(43) Pub. Date: Jul. 16, 2026

(54) Method and Apparatus for a Multi-input Multi-output Large Language Model

(71) Applicant: Thaddeus Gabara, Murray Hill, NJ (US)

(72) Inventor: Thaddeus Gabara, Murray Hill, NJ (US)

(21) Appl. No.: 19/428,118

(22) Filed: Dec. 20, 2025

Related U.S. Application Data
(60) Provisional application No. 63/737,713, filed on Dec. 22, 2024.

(51) Int. Cl. G06N 3/045; G06N 3/0464; G06N 3/063

(52) U.S. Cl. CPC G06N 3/045; G06N 3/0464; G06N 3/063

(57) ABSTRACT

This disclosure introduces a “Super-LLM” architecture integrating multiple interconnected “daughter” Large Language Models (LLMs). By sharing internal layer information and utilizing multi-input, multi-output ports, the system processes simultaneous prompts with enhanced accuracy and reduced hallucinations. The design emphasizes hardware implementation, proposing identical neural networks fabricated on single CMOS chips using precision analog matching. This enables direct state sharing and dynamic layer reconfiguration via caches. Optimized for agentic systems, the Super-LLM facilitates autonomous communication and complex task orchestration by allowing internal models to share awareness and feedback loops within a unified, high-performance computational framework.

### RELATED APPLICATIONS

The present patent application claims the benefit and priority of the filing date under 35 U.S.C. 119(e) of Provisional U.S. patent application Ser. No. 63/737,713, filed Dec. 22, 2024, entitled Method and Apparatus for a Multi-input Multi-output Large Language Model, which is hereby incorporated by reference in their entirety.

### BACKGROUND OF THE INVENTION

Artificial Neural Networks (“ANN”), or also called a “Neural Network” (“NN”), is an electronic computational network that tries to mimic the structure and behavior of the neuron network found in the human brain. In the brain, the output signals of the current layer travel down an axon or dendrite to forward the newly calculated information to the next neuron. These axons or dendrites are like interconnects and carry some portion (“weight”) of the newly calculated information to the destination. The neuron in the electrical circuit is often called a “node”. It has been found that numerous neurons fire together in the brain; in ways, this is similar to a “layer” in said NN where the nodes can be arranged in one of many columns. The number of nodes in this layer determines the “width” of the layer. When all the nodes in the layer are modifying the information that is flowing from all the nodes in an earlier layer to the next layer, then the “full width” of the layer is being used. In a “fully connected neural network” (“FCNN”), every node in a first layer is connected to and influences every node in the next layer using a weight, which influences the next layer and so on for the following layer. “Input signals” are provided to the first layer (called the “input layer”), then the first layer sends its signals to the second layer, the second layer to the third layer, and so on (called the “hidden layers”), until the signals finally arrive at the last layer (called the “output layer”). The output layer generates a “response”. Note that in a fully connected neural network, all the input signals are connected via the neural network to all of the output signals. When there are many layers in a NN, it is called a “Deep Neural Network” (“DNN”). Neural networks can learn and trained to categorized unknown things, use statistics to predictive outcomes, or solve problems in artificial intelligence (AI).

Large Language models (LLM) uses natural language processing machines that perform intelligent language processing tasks. LLMs are trained on massive amounts of data to improve their predictive power. The training can take long periods of compute time and the training includes supervised learning and fine-tuning. The LLM is comprised of a plurality of artificial neural networks that, in one embodiment, can be configured into a decoder architecture, i.e., a decoder-only transformer-biased architecture. Multi-modal LLM's can extract information from text, sound, images, and movies and use that extracted information to perform one or more tasks. Multi-modal LLM's can be tasked to understand natural language instructions and generate outputs: text, sound, images, or movie outputs. However, LLMs suffers from hallucinations and these faulty responses may be provided to the user. To overcome this, an architecture called Retrieval Augmented Generation (RAG) can be built around the LLM to extract more accurate information and decrease the generation of hallucinations. The architecture to perform this function includes a memory that stores more recent and pertinent information for use. Many different architectures started to be built around LLMs, and many companies who offer software framework (LangChain, LamaIndex, Haystack, CrewAI, etc.), grew as a result.

Prompt Engineering (PE) is a technique of communicating with an LLM to extract a desired, robust and improved response from a query of the LLM. One of the rules of PE is “dividing complex tasks”. Complex tasks should be divided into smaller manageable steps. The LLM works best on a prompt when the prompt only addresses one of several complex tasks. This makes sense since the LLM works on one prompt at a time. Another technique-advanced prompting technique called “Persona-based Prompting” defines the LLM to act, behave, and react like a specific persona. The LLM can be instructed to have several personas.

Agents use LLMs, memory, function calling, and tools to interact together to achieve some goal. The memory, for example, remembers past events and the system orchestrates the agents using function calling to perform more complex tasks by using tools that can interact with the world more autonomously. Agents can also act together to perform these more complex tasks with less human interaction. Each of the agents are given specific human instructions that is stored in local memory whereby each of the agents perform various portions of a given task following these stored human instructions until the task is complete. The multi-agentic system is a more complex LLM system. In some cases, information may need to be processed by a plurality of agents, which can be configured as parallel-connected, series-connected, or any combination of the two. Each agent can interact with one or more LLMs, when agents need to channel and process the information flow along numerous numbers of coupled LLMs, the agents need to orchestrate when to do what. Software Agentic framework companies (CrewAI, AutoGen, JARVIS) have grown to provide automatic agentic design.

The present document presents methods and systems for enhancing and improving the operation and accuracy of NNs. Many scientists have admitted that the exact operation of a very complex network such as the NN is not completely understood. In principle, the operation of the NN is understood but how the NN goes about solving these problems is lost to complexity of the network. However, a better understanding of NNs could improve the design of various variants of NNs. Some of these variants of NNs are used to build or construct LLMs; thus, LLMs rely on NNs. Agentic design is built on the back of LLMs and the LLMs are built on the back of NNs. Thus, any technique that can shed light on the operation and behavior of NNs, leads to a better understanding of the operation of an NN, and to allow the use of NNs in new ways would be a useful and beneficial to the domain of LLMs and to agentic design. Such techniques would be beneficial to the world of artificial intelligence (AI).

### BRIEF SUMMARY OF THE INVENTION

One of the embodiments of this disclosure is increasing the number of different input prompts to a single master LLM.

One of the embodiments of this disclosure is decreasing the solution time of LLMs which is beneficial since a solution can be provided earlier. Thus, agents and LLMs can benefit from an LLM that at least has an improved performance while providing an improved level of accuracy. In order to improve the operation and accuracy of LLMs is to incorporate one or more daughter LLMs into a Super-LLM. In one embodiment, the number of all of the daughter's input and output ports of their individual LLMs within the Super-LLM sum up to the all of the input and total output ports of their parent, the length of the daughter's LLM equals to the length of said Super LLM, wherein at least one artificial neural network in each of the daughter's LLM extends into the domain of one or more other daughter paths, wherein
information from one daughter path can be shared with one or more other daughter paths, wherein said information that is shared during testing helps to train each of the daughter's awareness of each other, wherein when each daughter receives a prompt, the solution may include addition information to the solution due to the contributions of any of those daughters that may have shared information in the past.

Stochastic gradient descent is an algorithm that is used to train a wide variety of machines, focused on machine learning, for example, logistic regression. Artificial neuron networks are trained using a back propagation algorithm to calculate the gradient of the loss function. The difference between the measured value and the predicted value is a value we are interested in minimizing.

First, see if co-inhabitants agents recognize each other. If not, then how will the agents recognize each other with n =2. Give the first question to first LLM then give a second question to second co-inhabitant LLM. If they do, that a sign of identity.

Use two LLM's in the same Super-LLM as agents in a system. Memory is added to the system. Then each agent shares the questions of others due to the shared memory and sees the answer in the network of the trained neural network. A different question is presented to both LLM's, the partition allows each agent to know who is talking. State can be assigned to each agent so that any LLM can know and retain who is currently communicating. So one can switch back and forth using the assigned agents. In other words, the first LLM can respond as Tom, Dick, or Mary, while the second LLM can respond as Barbara, Louis, or Brad. Thus, Tom, Dick, and Mary can communicate to Barbara, Louis, and Brad in a back and forth scenario forming a loop where the Single Super-LLM is, in effect, talking to itself.

The next aspect is to train LLM with mood. Word prediction would be better since the guesses for the next token or word would improve. A PLA (Programmable Logic Array) can be used in the feedback loop, where the PLA adjustable can assign portions of input tokens of LLM for moods. Mood can be defined by time, degree of mood, or angry. The PLA feeds back to itself where some tokens are human derived and some machine derived. A human trains the agent through PLA then lets feedback take over. The LLM is given the map of the PLA and then gives power to the LLM to take over. The PLA can be as wide as the LLM and as long as necessary to cover all possibilities of the array that the LLM needs to perform its duties.

Another aspect is to exor two token streams where each token stream contains independent data. Calculate the input response for each of the two token streams and exor the results of the LLM responses to get an output result. These exor results can be monitored for commonality. Memory can be used to store these results and get back to a starting point.

LLMs machine size will continue getting smaller and smaller. It will move from the size of a desktop to that of a small box that will be wirelessly connected to your cell-phone. Even the cell-phone will contain one or more LLMs. The personal LLM is there for you when you need it. Have in a car, at home, in a cell-phone for use. Everyone, even children, will eventually have a personal LLM for their use.

In a Super-LLM that organized as a plurality of LLMs. Some of the LLMs may share some layers together, separate from the others. In addition, the selection of sharable paths is Boolean selectable. So the plurality of LLMs can reconfigure a portion themselves to make selected sharable paths at different times as needed and deciding what layers in various locations should be shared or not.

A plurality of LLMs that transfer a state in a circular path comprising of the Super-LLMs. A Super-LLM comprises a plurality of LLMs. In one case, a plurality of identical LLMs that are clocked at certain layer boundaries, information at output nodes of a first certain layer on each LLM is transferred contents of a selected layer. A plurality of identical LLMs where a output portion of information from one layer is switched to an input portion of an equivalent layer boundaries, information at output nodes of a first certain layer on each LLM is transferred contents of a selected layer are

Compare a neural network with itself. That way, when two identical models are compared against each other, there is much to be learned. The difficulty is making two identical neural networks. The circuit building components of neural network would include P-channel Metal-Oxide Semiconductor (PMOS) and N-channel Metal-Oxide Semiconductor (NMOS) transistors fabricated in a foundry manufacturing integrated circuit technology called Complementary Metal-Oxide-Semiconductor (CMOS). Of all the integrated circuit chips or chiplets produced in the world today, almost 99% of their semiconductor chips are fabricated using CMOS. CMOS has a number of advantages. As the technology progresses, some of the benefits include: the transistors scale down in size, more transistors can be placed in a given area, and the transistors are manufactured at the same time in the same environment and therefore should behave identically.

In one embodiment, two or more identical neural network circuits are fabricated in the CMOS technology where the layout of the neural networks uses all know analog techniques that are used to match the behavior of fabricated transistors on a die. These techniques help to compensate for variations in chip manufacturing due to manufacturing process variations, environmental temperature gradients, and lithography accuracy. Transistor parameters when they are manufactured are sensitive to distance from another transistor, the orientation compared to a reference direction, and uniformity of layout. Some of the techniques to compensate for these conditions are Common Centroid matching and Rotational Symmetry.

In another embodiment, the two or more identical neural network circuits that use all these compensating techniques and further placing the corresponding transistors of the same network of the two NN together so that the transistors behave the same as one another due to their close relative position to one another. Thus, making two identical NN may be possible and once they are powered, if they are nearly identically matched, the voltages inside the two NNs would be similar. Test tools can be used to perform the comparisons and offer several alternatives of investigating different methods of compensating the behavior of the second NN to be near to exact of a copy as the first NN. If the internal voltages between the two NNs are substantially different, yet both always have the same response to a common data input, the test tool can measure the deviance of the voltage difference before an error occurs. Analyze the results. Find the mean, average, and other statistical measurements that might provide a hint to make the resultant voltage between the two NN more equal. This study shows how the voltages change as the same new data is applied to both NNs for inference. This can measure a drift of the weight values during use.

On the other hand, in another embodiment, the internal nodes of the second NN can be made to match the measured internal voltages of the first NN. In one embodiment, once these values are applied to the weights between the first and second layers of the second NN, let these values propagate through the remaining layers of the second NN till reaching the output. Keep repeating this “training” over and over again. This will occur by measuring the voltages in the first NN then to compare the voltage with the second LLM and force those voltages.

Need to copy voltage and selectively force the voltage of the weights in the same corresponding layer in a second NN that has been trained similarly. Loop the output back to the input, open the connection between the first and second layers, now new inputs and output have been defines for this modified “fully connected neural network”. But the inputs to the new input of this “slipped layer NN” (SLNN) are in a different language then the initial data presented to the original NN. If we look at the output of the SLNN, we see one most recent data input that can be used to train the SLNN. Instead of using this data input to train the SNN, the data input becomes the reference. Loop it to redefine the input/output layers. Turn off interconnect between first layer to second layer. All layers should be trained. One rule is to break a network where it is full width. Two identical NNs have equivalent states (or vectors) between corresponding layers.

Another enabling process includes training a first NN identically as a second NN. Randomly select and measure a first voltage of a weight from a given layer of a first NN. Measure all corresponding weights in the second NN equivalent to said given layer. Determine the weight in the second NN that has a minimum distance from the first voltage and measuring all corresponding weights in the second NN.

The voltages of the weights in a first NN should match, within some tolerance, the voltage of the weights in the second NN, where the first and second NN are fabricated together, at the same time, near one another, on the same piece of silicon in some chip foundry. All clever analog technique are used in attempts to match a given component in the first NN to an identical corresponding component in the second NN. Assume for simplicity, that the second NN is identical in all ways (network architecture, widths of layers, number of layers, circuit schematics, transistor dimensions, orientation, relative placement, etc.) to the first NN. They are substantially mirrors images of the other. This helps to match the actual behavior of the electronic circuits within the first and second NNs such that the corresponding voltages between the two NNs should be equal within some variance.

Furthermore, assume that both NNs have been trained exactly the same, with the same inputs, at the same time, in the same environment of the silicon chip. For a given input applied to both NNs, the values of the voltages of the weights at a given layer of the first NN should match the values of the voltages of the weights at said given layer of the second NN. These voltages of the two NNs can be measured and stored in memory. An analysis can be performed on the measured information to determine how close the voltages at various points, as specified by a circuit schematic, within the first NN match the voltages of corresponding points in the second NN. Whoever receives information is more knowledgeable. The more information one has, the better the decision.

So if the entire layer of a first NN is also applied to the same one-on-one correspondence nodes and weights of the second NN. The information given doubles the knowledge at that instant. Two NNs fabricated in silicon on one die, identically trained with the same data while not sharing internal state, can be tested to make a one-to-one correspondence. The two NNs are identically trained with the same data while not sharing internal state.

Entire width is either passed straight through or transferred to the right. Using CMOS resistive transmission gate to form a Path, the Path conducts or communicates Boolean or analog signals. The two LLMs interchange layers between each other. Entire width is either passed straight through or transferred to the right. Using CMOS resistive transmission gate to form a Path, the Path conducts or communicates Boolean or analog signals. Note: There is a similarity of data in NN to prompts in Large Language Models (LLM).

In one embodiment, a multi-input Large Language Model (LLM) intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length, wherein an output from said first input layer or said one of said first plurality of connected hidden layers of said first LLM is applied as an input to a corresponding next layer of said second LLM. The system wherein an output from said second input layer or said one of said second plurality of connected hidden layers of said second LLM is applied as an input to a corresponding next layer of said first LLM. The system wherein all outputs from said first input layer or said all outputs of at least one of said first plurality of connected hidden layers of said first LLM are applied as an input to a corresponding next layer of said second LLM. The system wherein all outputs from said second input layer or said all outputs of at least one of said second plurality of connected hidden layers of said second LLM are applied as an input to a corresponding next layer of said first LLM. The system wherein all convolutional outputs from said first input layer or said all convolutional outputs of at least one of said first plurality of connected hidden layers of said first LLM are applied as an input to a corresponding next layer of said second LLM. The system wherein all convolutional outputs from said second input layer or said all convolutional outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input LLM intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length, wherein an output from said first input layer or said one of said first plurality of connected hidden layers of said first LLM is applied as an input to a corresponding next layer of said second LLM, and wherein an output from said second input layer or said one of said second plurality of connected hidden layers of said second LLM is applied as an input to a corresponding next layer of said first LLM. The system wherein all outputs from said first input layer or said all outputs of at least one of said first plurality of connected hidden layers of said first LLM are applied as an input to a corresponding next layer of said second LLM. The system wherein all outputs from said second input layer or said all outputs of at least one of said second plurality of connected hidden layers of said second LLM are applied as an input to a corresponding next layer of said first LLM. The system wherein all convolutional outputs from said first input layer or said all convolutional outputs of at least one of said first plurality of connected hidden layers of said first LLM are applied as an input to a corresponding next layer of said second LLM. The system wherein all convolutional outputs from said second input layer or said all convolutional outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input LLM intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length, wherein all outputs from said first input layer or said all outputs of at least one of said first plurality of connected hidden layers of said first LLM are applied as an input to a corresponding next layer of said second LLM. The system wherein all outputs from said second input layer or said all outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input LLM intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length, wherein all convolutional outputs from said first input layer or said all convolutional outputs of at least one of said first plurality of connected hidden layers of said first LLM are applied as an input to a corresponding next layer of said second LLM. The system wherein all convolutional outputs from said second input layer or said all convolutional outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input LLM intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length, wherein convolutional outputs from said first input layer or some convolutional outputs of at least one of said first plurality of connected hidden layers of said first LLM are applied as an input to a corresponding next layer of said second LLM, wherein remaining outputs from said first input layer or said remaining outputs of at least one of said first plurality of connected hidden layers of said first LLM are applied as an input to a corresponding next layer of said second LLM, wherein convolutional outputs from said second input layer or some convolutional outputs of at least one of said second plurality of connected hidden layers of said second LLM are applied as an input to a corresponding next layer of said first LLM, and wherein remaining outputs from said second input layer or said remaining outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input multi-output Neural Network (NN) intelligent system comprising: a first NN, comprising: a first input layer having a first plurality of nodes, connected to nodes of a first hidden layer of a first plurality of connected layers of hidden layers of nodes, wherein a first data is provided to said first plurality of nodes; a first output layer having a second plurality of nodes having a first output context length, connected to a last hidden layer of said first plurality of connected hidden layers of nodes, wherein due to said first data, a first response outputted from said second plurality of nodes forming said first output context length; and a second NN, comprising: a second input layer having a third plurality of nodes, connected to nodes of a first hidden layer of a second plurality of connected layers of hidden layers of nodes, wherein a second data is provided to said third plurality of nodes; a second output layer having a fourth plurality of nodes having a second output context length, connected to a last hidden layer of said second plurality of connected hidden layers of nodes, wherein due to said second data, a second response outputted from said fourth plurality of nodes forming second output context length, and wherein an output from said first plurality of nodes or an output from said one of said first plurality of connected hidden layers of nodes of said first NN are applied as an input to a corresponding next layer of said second NN. The system wherein an output from said third plurality of nodes or an output from said one of said second plurality of connected hidden layers of nodes of said second NN are applied as an input to a corresponding next layer of said first NN. The system wherein all outputs from said first plurality of nodes or said all outputs of at least one of said first plurality of connected hidden layers of nodes of said first NN are applied as an input to a corresponding next layer of said second NN. The system wherein all outputs from said third plurality of nodes or said all outputs of at least one of said second plurality of connected hidden layers of nodes of said second NN are applied as an input to a corresponding next layer of said first NN. The system wherein all convolutional outputs from said first plurality of nodes or said all convolutional outputs of at least one of said first plurality of connected hidden layers of nodes of said first NN are applied as an input to a corresponding next layer of said second NN. The system wherein all convolutional outputs from said third plurality of nodes or said all convolutional outputs of at least one of said second plurality of connected hidden layers of nodes of said second NN are applied as an input to a corresponding next layer of said first NN. The system wherein said NNs are identical. The system wherein said NNs have previously been handled and trained identically with identical prompts and all types of testing and initializing. The system wherein said first NN and said second NN can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input Large Language Model (LLM) intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length, wherein a given layer in said first LLM is exchanged with a same given layer in said second LLM, wherein an output from said first input layer or said one of said first plurality of connected hidden layers of said first LLM is applied as an input to a corresponding next layer of said second LLM. The system of wherein a first given layer in said first LLM is exchanged with a second layer in cache, and a second given layer in said second LLM is exchanged with a fourth layer in cache. The system of wherein an output from said second input layer or said one of said second plurality of connected hidden layers of said second LLM is applied as an input to a corresponding next layer of said first LLM. The system of wherein all outputs from said first input layer or said all outputs of at least one of said first plurality of connected hidden layers of said first LLM are applied as an input to a corresponding next layer of said second LLM. The system of wherein all outputs from said second input layer or said all outputs of at least one of said second plurality of connected hidden layers of said second LLM are applied as an input to a corresponding next layer of said first LLM. The system of wherein all convolutional outputs from said first input layer or said all convolutional outputs of at least one of said first plurality of connected hidden layers of said first LLM are applied as an input to a corresponding next layer of said second LLM. The system of wherein all convolutional outputs from said second input layer or said all convolutional outputs of at least one of said second plurality of connected hidden layers of said second LLM are applied as an input to a corresponding next layer of said first LLM. The system of wherein said LLMs are identical. The system of wherein said LLMs have previously been handled and trained identically with identical prompts and all types of testing and initializing. The system of wherein at least a same portion said first LLM and said second LLM can be fabricated on a single integrated CMOS circuit chip. The system of wherein a total width of an input context size of said system is equal to a summation of widths of said first input layer and said second input layer. The system wherein a total width of an output context size of said system is equal to a summation of widths of said first output context length and said second output context length.

In another embodiment, a multi-input Large Language Model (LLM) intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length, wherein a first given layer in said first LLM is exchanged with a second layer in cache, and a second given layer in said second LLM is exchanged with a fourth layer in cache, wherein an output from said first input layer or said one of said first plurality of connected hidden layers of said first LLM is applied as an input to a corresponding next layer of said second LLM. The system wherein a given layer in said first LLM is exchanged with a same given layer in said second LLM. The system wherein an output from said second input layer or said one of said second plurality of connected hidden layers of said second LLM is applied as an input to a corresponding next layer of said first LLM. The system wherein all outputs from said first input layer or said all outputs of at least one of said first plurality of connected hidden layers of said first LLM are applied as an input to a corresponding next layer of said second LLM. The system wherein all outputs from said second input layer or said all outputs of at least one of said second plurality of connected hidden layers of said second LLM are applied as an input to a corresponding next layer of said first LLM. The system wherein all convolutional outputs from said first input layer or said all convolutional outputs of at least one of said first plurality of connected hidden layers of said first LLM are applied as an input to a corresponding next layer of said second LLM. The system wherein all convolutional outputs from said second input layer or said all convolutional outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input Large Language Model (LLM) intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length; a cache to exchange layers with said first LLM or with said second LLM or both, wherein an output from said first input layer or said one of said first plurality of connected hidden layers of said first LLM is applied as an input to a corresponding next layer of said second LLM. The system wherein a given layer in said first LLM is exchanged with a same given layer in said second LLM. The system wherein an output from said second input layer or said one of said second plurality of connected hidden layers of said second LLM is applied as an input to a corresponding next layer of said first LLM. The system wherein all outputs from said first input layer or said all outputs of at least one of said first plurality of connected hidden layers of said first LLM are applied as an input to a corresponding next layer of said second LLM. The system wherein all outputs from said second input layer or said all outputs of at least one of said second plurality of connected hidden layers of said second LLM are applied as an input to a corresponding next layer of said first LLM. The system wherein all convolutional outputs from said first input layer or said all convolutional outputs of at least one of said first plurality of connected hidden layers of said first LLM are applied as an input to a corresponding next layer of said second LLM. The system wherein all convolutional outputs from said second input layer or said all convolutional outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input Large Language Model (LLM) intelligent system comprising: a first LLM, comprising: a first input layer having a first context length, connected to a first hidden layer of a first plurality of connected hidden layers, wherein a first prompt is provided to said first input layer; a first output layer having a first output context length, connected to a last hidden layer of said first plurality of connected hidden layers, wherein due to said first prompt, a first response is provided within said first output context length; and a second LLM, comprising: a second input layer having a second context length, connected to a first hidden layer of a second plurality of connected hidden layers, wherein a second prompt is provided to said second input layer; a second output layer having a second output context length, connected to a last hidden layer of said second plurality of connected hidden layers, wherein due to said second prompt, a second response is provided within said second output context length; a cache to exchange layers with said first LLM or with said second LLM or both; a first plurality of agentic loops formed with said first LLM; a second plurality of agentic loops formed with second first LLM, wherein an output from said first input layer or said one of said first plurality of connected hidden layers of said first LLM is applied as an input to a corresponding next layer of said second LLM. The system wherein a given layer in said first LLM is exchanged with a same given layer in said second LLM. The system wherein an output from said second input layer or said one of said second plurality of connected hidden layers of said second LLM is applied as an input to a corresponding next layer of said first LLM. The system wherein all outputs from said first input layer or said all outputs of at least one of said first plurality of connected hidden layers of said first LLM are applied as an input to a corresponding next layer of said second LLM. The system wherein all outputs from said second input layer or said all outputs of at least one of said second plurality of connected hidden layers of said second LLM are applied as an input to a corresponding next layer of said first LLM. The system wherein all convolutional outputs from said first input layer or said all convolutional outputs of at least one of said first plurality of connected hidden layers of said first LLM are applied as an input to a corresponding next layer of said second LLM. The system wherein all convolutional outputs from said second input layer or said all convolutional outputs of at least one of said second plurality of connected hidden layers of said second LLM are applied as an input to a corresponding next layer of said first LLM. The system wherein said LLMs are identical. The system wherein said LLMs have previously been handled and trained identically with identical prompts and all types of testing and initializing. The system wherein at least a same portion said first LLM and said second LLM can be fabricated on a single integrated CMOS circuit chip. The system wherein a total width of an input context size of said system is equal to a summation of widths of said first input layer and said second input layer. The system wherein a total width of an output context size of said system is equal to a summation of widths of said first output context length and said second output context length.

In another embodiment, a multi-input Agentic Large Language Model (LLM) intelligent system comprising: a Super-LLM with first and second related input prompts and first and second related output responses; a first action is searched in a memory of said first related output response and a second action is searched in said memory in said second related output response; in conjunction with said memory and said action, a first observation is made; in conjunction with said memory and said action, a first observation is made; a first feedback is determined using said first observation and a second feedback is determined using said second observation; said Super-LLM is reapplied with said first feedback and said second feedback as said first and said second prompts to continue process until said first and said second actions are completed.

### BRIEF DESCRIPTION OF THE DRAWINGS

Please note that the drawings shown in this specification may not necessarily be drawn to scale and the relative dimensions of various elements in the diagrams are depicted schematically. This disclosure presented here may be embodied in many different forms and should not be construed as limited to the embodiments set forth herein. Rather, these embodiments are provided so that this disclosure will be thorough and complete, and will fully convey the scope of the disclosure to those skilled in the art. In other instances, well-known structures and functions have not been shown or described in detail to avoid unnecessarily obscuring the description of the embodiment of the disclosure. Like numbers refer to like elements in the diagrams.

FIG. 1A shows a fully-connected neural network in the present disclosure.

FIG. 1B depicts a training setup of a fully-connected neural network in the present disclosure.

FIG. 1C depicts the components (circuit, mathematical, block diagram) of an artificial neuron in the present disclosure.

FIG. 1D shows two types of ‘non linear’ activation functions in the present disclosure.

FIG. 1E illustrates graphs depicting the backward-propagation path differentials in the present disclosure.

FIG. 2A depicts two identical but separate NNs being trained identically in the present disclosure.

FIG. 2B depicts a table presenting the characteristics of the two NNs of FIG. 2A in the present disclosure.

FIG. 3A show two identical but separate NNs fabricated on a silicon chip, in one embodiment, measured for voltages based around a “from” node within the network in accordance with the present disclosure.

FIG. 3B depicts two identical but separate NNs measured for voltages in another embodiment based around a “to” node within the network in accordance with the present disclosure.

FIG. 3C shows depicts two identical but separate NNs measured for voltages in yet another embodiment based around a “to” node within a previous layer within the network in accordance with the present disclosure.

FIG. 3D illustrates (top) one embodiment of a circuit/block diagram with switches to pass voltages and (bottom) a transistor representation of a CMOS transmission gate of the switch schematic in accordance with the present disclosure.

FIG. 4A depicts one embodiment of a one-to-one correspondence between the inputs and outputs of two identical pre-trained NNs in accordance with the present disclosure.

FIG. 4B illustrates another embodiment of a one-to-one correspondence of measured voltages of the weights in the output layer of two identical pre-trained NNs with and without Gaussian noise in accordance with the present disclosure.

FIG. 4C shows the predicted voltages of the one-to-one correspondence between two identical pre-trained NNs with and without Gaussian noise in accordance with the present disclosure.

FIG. 5A shows one embodiment of a flowchart of comparing the voltages of weights between two identical NNs in accordance with the present disclosure.

FIGS. 5B-C illustrates another embodiment of a flowchart of comparing the voltages of weights to determine bijection between two identical NNs in accordance with the present disclosure.

FIG. 6A depicts one embodiment of measuring and forcing the voltages from a first NN to a second NN in accordance with the present disclosure.

FIG. 6B depicts one embodiment of a flowchart to measure and force voltages of weights in accordance with the present disclosure.

FIG. 6C show example analog and digital circuits to help control current and voltages in accordance with the present disclosure.

FIG. 6D depicts an embodiment of a flow chart comparing and swapping voltages in accordance with the present disclosure.

FIG. 7A shows an embodiment of two identical NNs where the top NN is providing information to the lower NN in accordance with the present disclosure.

FIG. 7B illustrates a table presenting the characteristics of the two non-separate NNs of FIG. 7A in accordance with the present disclosure.

FIG. 7C depicts anther embodiment of two identical NNs where the top NN and lower NN exchange information in accordance with the present disclosure.

FIG. 7D presents a table presenting the characteristics of the two non-separate NNs of FIG. 7C in accordance with the present disclosure.

FIG. 7E illustrates one embodiment of convolution kernels of a shared-weight architecture (convolutional) and a fully connected neural network (FCNN) within a single NN.

FIG. 7F illustrates one embodiment between a pair of NNs of convolution kernels of a shared-weight architecture (convolutional) and a fully connected neural network (FCNN) with the present disclosure.

FIG. 8A shows two identical deep NNs in accordance with the present disclosure.

FIG. 8B shows one embodiment of signals sourced from a node in a layer in the top NN and provided to a node in the next layer of the bottom NN in accordance with the present disclosure.

FIG. 8C illustrates another embodiment of signals sourced from a node in a layer in the top NN and provided to a node in the next layer of the bottom NN where the original inputs to this node has been zeroed out in accordance with the present disclosure.

FIG. 8D depicts one embodiment of signals sourced from a later set of nodes in a layer in the bottom NN and provided to a node in the next layer of the top NN where the original inputs to this node has been nulled out in accordance with the present disclosure in accordance with the present disclosure.

FIG. 9A depicts one embodiment of a NN with a single input prompt of context size N making predictions in the present disclosure.

FIG. 9B show how to partition the trained NN of FIG. 9A into two separate NN with two separate input prompts to train the upper and lower NNs independently in accordance with the present disclosure.

FIG. 10 depicts an embodiment of a block diagram of a plurality of neural networks within an LLM in accordance with the present disclosure.

FIG. 11 shows an embodiment of two identical LLMs in accordance with the present disclosure.

FIG. 12A illustrates an embodiment of four parallel LLMs with different widths in accordance with the present disclosure.

FIG. 12B depicts an embodiment of four LLMs with equal widths along the entire depth in accordance with the present disclosure.

FIG. 12C shows an embodiment of signals from one node in a layer of one LLM transfer over to a node in the next layer of another LLM making it a Super-LLM in accordance with the present disclosure.

FIG. 13A illustrates an embodiment of two LLMs each accepting an input prompt and generating an output response in accordance with the present disclosure.

FIG. 13B depicts an embodiment of a NN in the top LLM providing information to a similar NN in the lower LLM in accordance with the present disclosure.

FIG. 13C shows an embodiment of a NN in the top LLM and a similar NN in the lower LLM exchange information within the same layer in accordance with the present disclosure.

FIG. 13D depicts an embodiment of a NN in the top LLM and a similar NN in the lower LLM exchange information between more than one layer in accordance with the present disclosure.

FIG. 14A shows one embodiment of a trained LLM with an N context window and an output context window in accordance with the present disclosure.

FIG. 14B illustrates an embodiment of partitioning the N context window in half and partitioning the output in half of the LLM of FIG. 14A. The new LLMs will be fine-tuned by training the upper and lower LLMs in accordance with the present disclosure.

FIG. 15A depicts an embodiment of a LLM and an equivalent block diagram in accordance with the present disclosure.

FIG. 15B presents an embodiment of a Super-LLM accepting two prompts and generating two outputs and an equivalent block diagram in accordance with the present disclosure.

FIG. 15C illustrates another embodiment of a Super-LLM in parallel with an LLM where the Super-LLM accepts 3 prompts and generates three outputs in accordance with the present disclosure.

FIG. 15D shows that the context window of the Super-LLM matches the widths of the three context windows of the contained LLMs in accordance with the present disclosure.

FIG. 16 shows one embodiment of a pair of LLMs exchanging a particular Neural Network between the two LLMs in accordance with the present disclosure.

FIG. 17A illustrates a few embodiments of exchanging the output weights of a given layer in a software sense and a hardware sense in accordance with the present disclosure.

FIG. 17B depicts a few more embodiments of exchanging the output weights of a given layer in another direction in a software sense and a hardware sense in accordance with the present disclosure.

FIGS. 18A-D depicts an embodiment of a pair of LLMs exchanging a current NN with a pre-trained NN in accordance with the present disclosure.

FIG. 19 shows one embodiment of two LLMs exchanging data with each other and with a cache enhancing the operation of agentic loops built with the LLMs in accordance with the present disclosure.

FIG. 20 depicts an embodiment of 4 LLMs exchanging information in a counter-clockwise fashion enhancing the operation of agentic loops built with the LLMs in accordance with the present disclosure.

FIG. 21 shows an embodiment of one LLM exchanging information with three other LLMs enhancing the operation of agentic loops built with the LLMs in accordance with the present disclosure.

FIG. 22 illustrates an embodiment of an agentic system using four LLMs exchanging information between layers in one of many ways in accordance with the present disclosure.

FIG. 23 depicts an embodiment of a dual path agentic loop with a pair of LLMs in the Super-LLM, the bottom LLM was trained to observe by the top LLM by sharing some layer information in accordance with the present disclosure.

FIG. 24 shows an embodiment of a dual path agentic loop similar to FIG. 23 except for the memory being divided into a short and long term memories in accordance with the present disclosure.

FIG. 25 illustrates an embodiment of a dual path agentic loop similar to FIG. 24 except for the memory being shared in accordance with the present disclosure.

FIG. 26 shows an embodiment of a dual path agentic loop with a pair of LLMs in the Super-LLM, the bottom LLM was trained to monitor the memory while the top LLM was trained to determine behavior of the memory in accordance with the present disclosure.

FIG. 27 illustrates an embodiment of a dual path agentic loop where both LLMs are trained in accordance with the present disclosure.

### DETAILED DESCRIPTION OF THE INVENTION

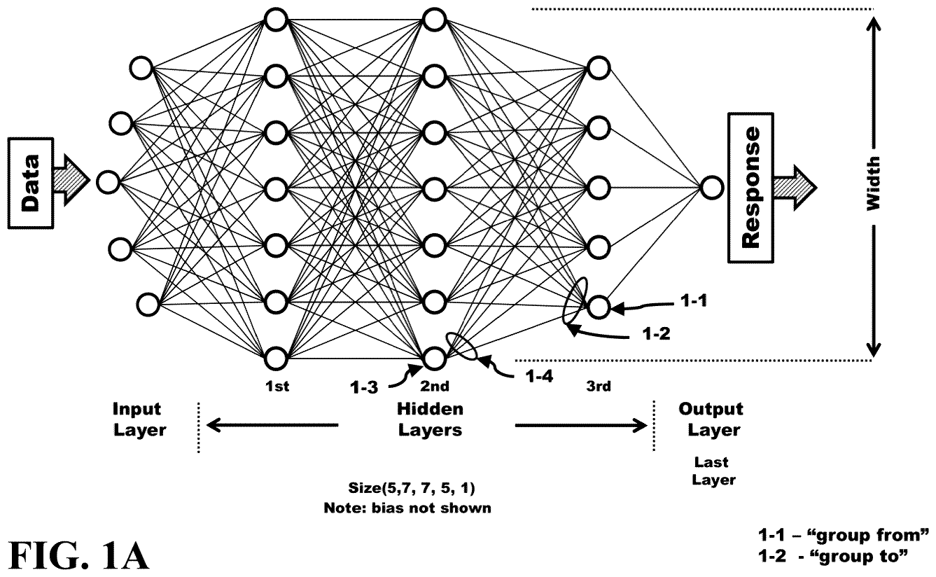

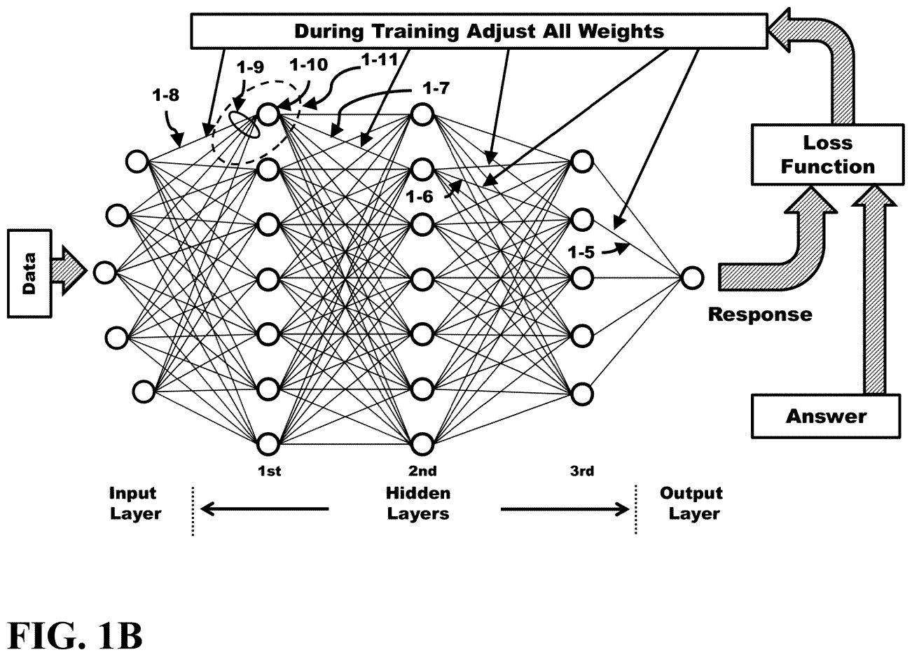

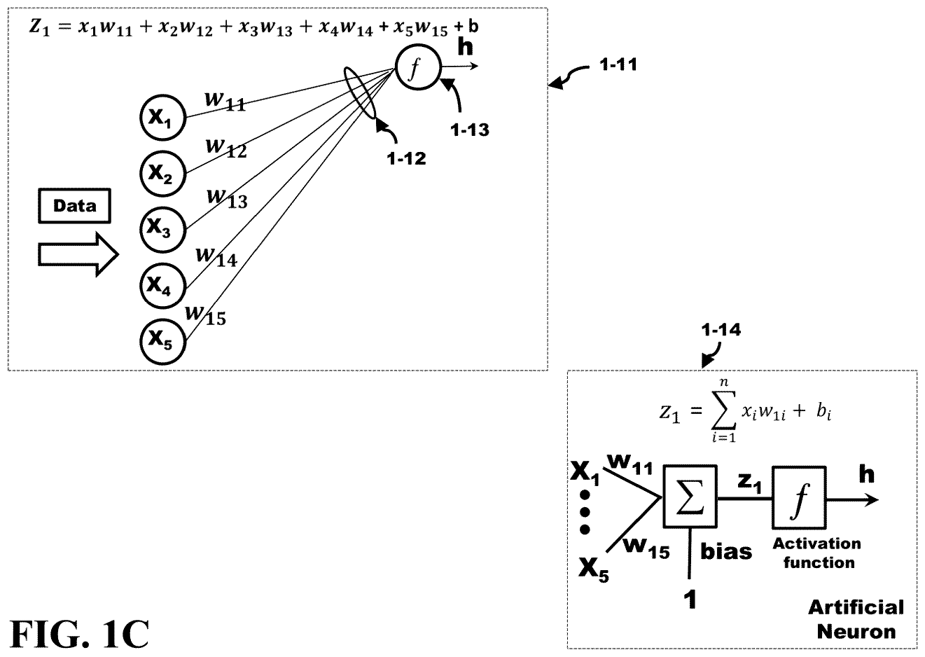

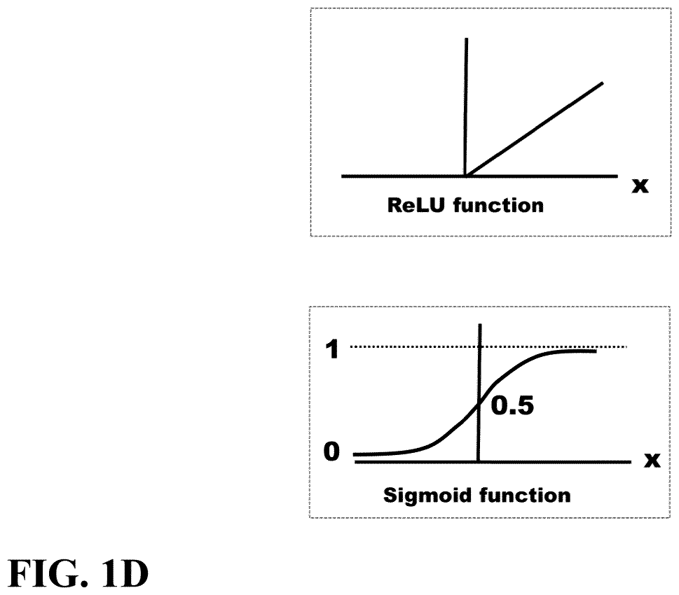

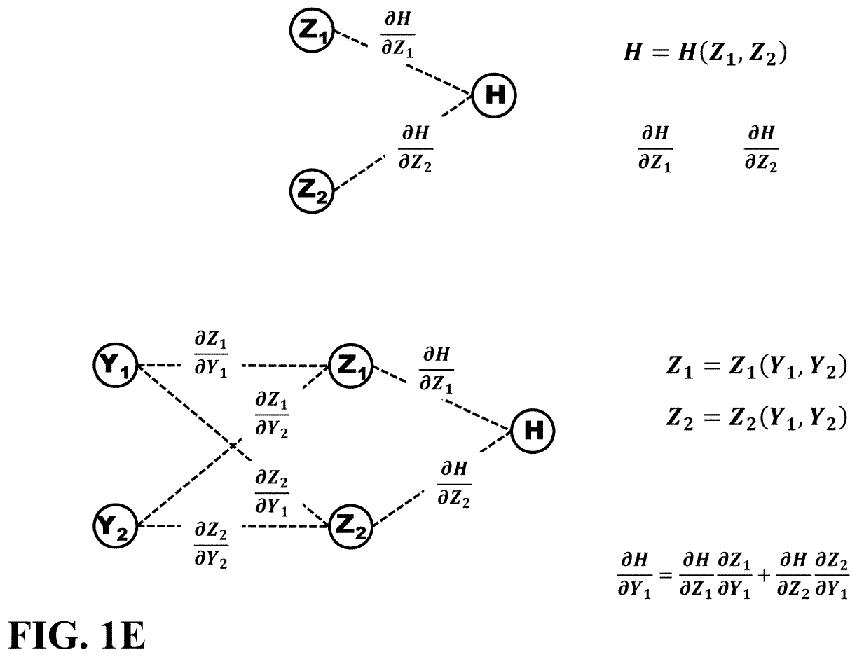

FIG. 1A shows one embodiment of an artificial neural network or simply neural network (NN) with size (5, 7, 7, 5, 1) or a first column of 5 nodes, next column 7 nodes, then 7 nodes, 5 nodes and 1 node. There are three hidden layers: 1^{st}, 2^{nd}, and 3^{rd}. The maximum width is 7 but other embodiments are not limited as such. Each column of nodes is called a layer. Every node of one layer is fully-connected to every node in the next layer. In other embodiments, the network may not be fully connected. The connection strength between each pair of nodes is determined by a weight. Data is applied at the input layer and the response is output in the outer layer. Being a fully-connected, the full width of the NN is used. Note that node 1-1 collects 7 weights “from” the previous layer. The oval 1-2 encloses these 7 connections and characterizes these 7 weights as a “group from”. The oval 1-4 encloses 5 connections “to” the nodes in the next layer. This group of 5 connections is characterized as a “group to” since they are going to the next layer.

FIG. 1B illustrates a block diagram of one embodiment of training the NN. A known matched pair of data and answer is provided, the NN generates a response. If the NN was fully trained, the response should match the answer. However, assume they do not match. Then, the loss function determines the difference and uses this information to calculate a loss, this loss is used to train the NN. The training adjusts the weights of the connections to minimize the loss. One of the many paths from the output layer back to the input layer is identified as: 1-5, 1-6, 1-7 and 1-8. Partial derivatives are used in back-propagation to calculate the appropriate weights of these 4 weights. The back-propagation calculation occurs for each and every path between the output and input layers.

The “group from” 1-9 collects the outputs of the nodes in the input layer. The collected inputs are applied to the node 1-10 in the 1^{st} layer, which in turn generates an output signal that is applied to the next layer via the 7 connections. The weights of these 7 connections have previously being determined during the previous training session. A more detailed view of the structure indicated in the dashed oval 1-11 is provided in the next figure.

FIG. 1C provides a view of 1-11 in the upper left. The data (x₁, x₂, x₃, x₄, x₅) is applied to the 5 nodes of the input layer. The “group from” 1-12 illustrates that 5 connections are made to node 1-13. Each of these connections is weighted using real numbers which was determined in the previously mentioned training step. The weights (w₁₁, w₁₂, w₁₃, w₁₄, w₁₅) multiply the input values (x₁, x₂, x₃, x₄, x₅), respectively. These are summed together and a bias (b) is added as the top equation in 1-11 illustrates. A block diagram of the artificial neuron is illustrated in 1-14. After z₁ is calculated, the value is applied to an activation function which is a non-linear function. The output (h) is applied to all the connections between the node 1-13 and the nodes in the next layer.

FIG. 1D illustrates two types of ‘non-linear’ activation functions. The top one is the Rectified Linear Unit (ReLu) function. The ReLu outputs the input value if it is greater than zero and outputs a zero if the input is negative. The bottom one is the sigmoid function which transforms the input value to lie between zero (0) and one (1).

FIG. 1E depicts some nodes and the partials that are calculated when doing a back-propagation which occurs during training. For a single step back, there is only one partial. But, as the steps back increase, there is more path diversity and the partials become more complicated.

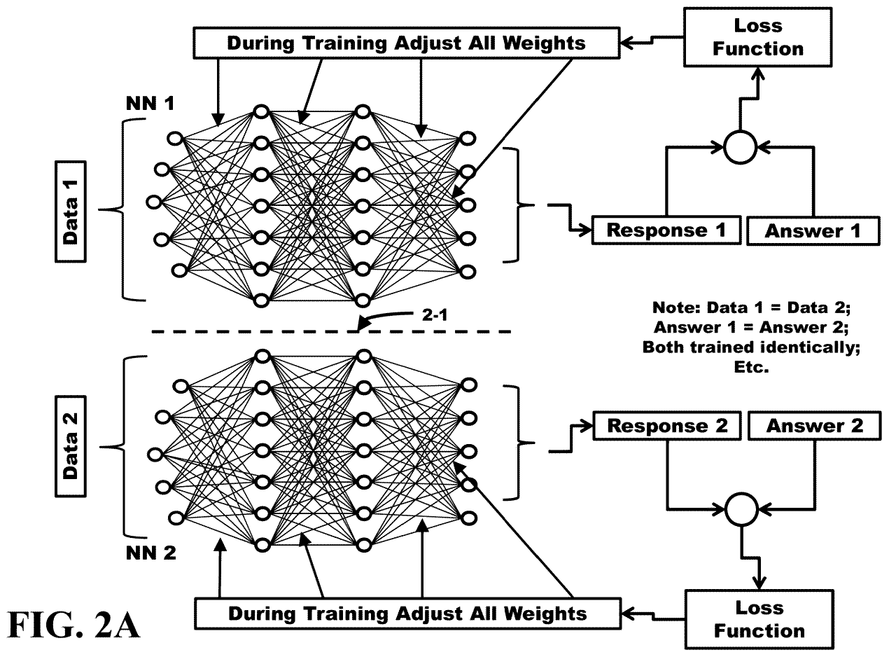

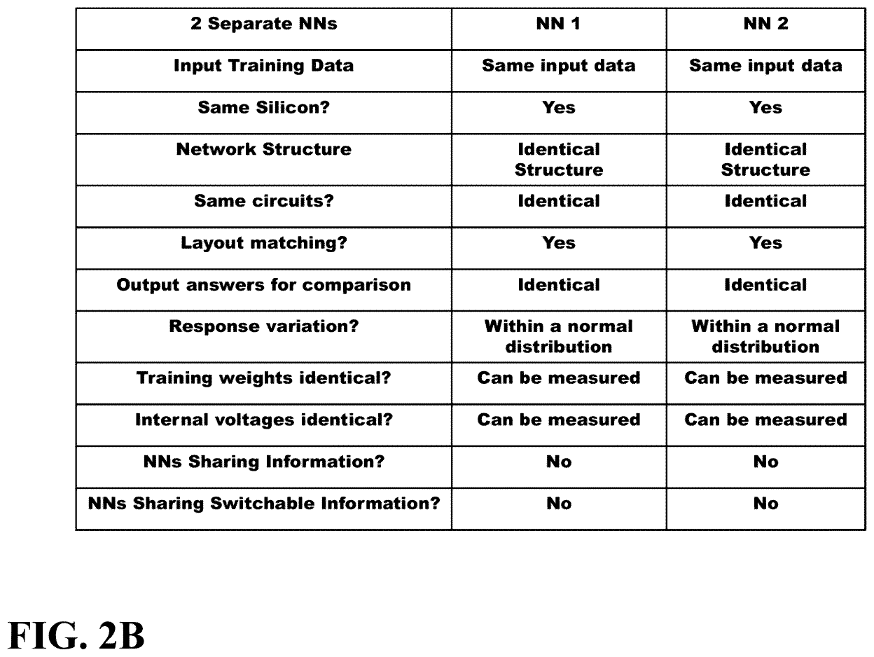

FIG. 2A shows one embodiment of two identical neural networks, fabricated in silicon together, and trained together by using the same inputs to the input data and the same answers for the given input data. The dotted line 2-1 indicates that these are separate NNs since nothing crosses this dotted line. Assume both NNs can be initialized to the same set of states by temporally connecting some nodes to either power or ground controlled by a reset switch, and then perform the training. Placing the circuit elements (transistors, etc.) close together on the die, use symmetrical layout techniques, use finger layout, common centroid layout, or rotational symmetry helps to match the two NNs.

FIG. 2B depicts a table comparing the two NNs. In this embodiment, both NNs were trained using the same data. Both NNs were fabricated on the same silicon die, both have the same network structure, both use the same circuits, and the same layout matching techniques were used. If the two NNs have been matched perfectly, then the real numbers of the voltages should be within a normal distribution. All voltages can be measured by using a switch which can tap into a circuit and transfer its voltage. These NNs are not sharing any information from the internal layers of the NNs with each other. In addition, these NNs do not have any switchable connections to the other NN. A switchable connection is one that demonstrates a connection at a first instant and eliminates the connection at another instant. In some cases, the elimination does not affect the operation of the remaining circuitry.

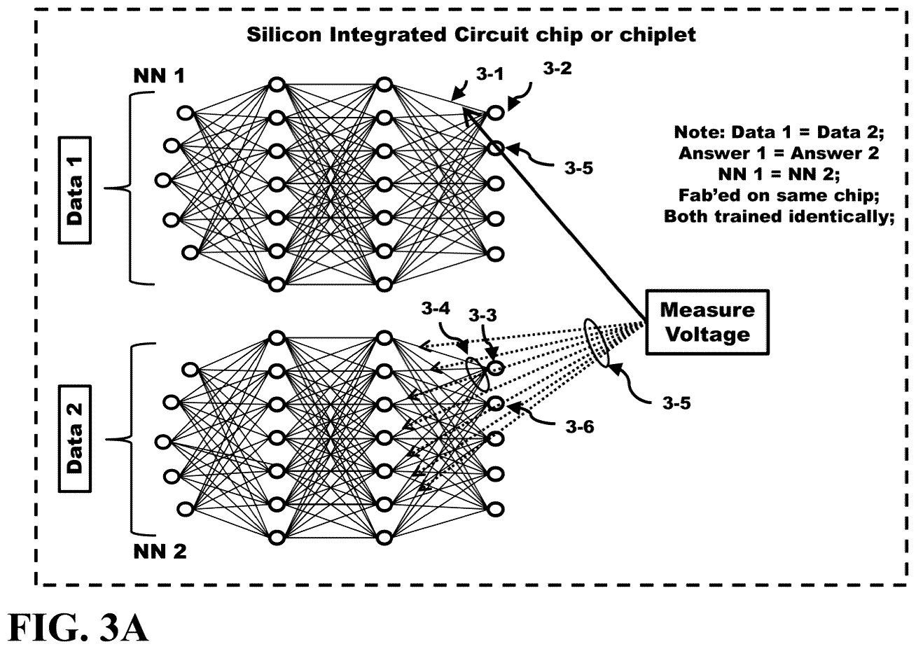

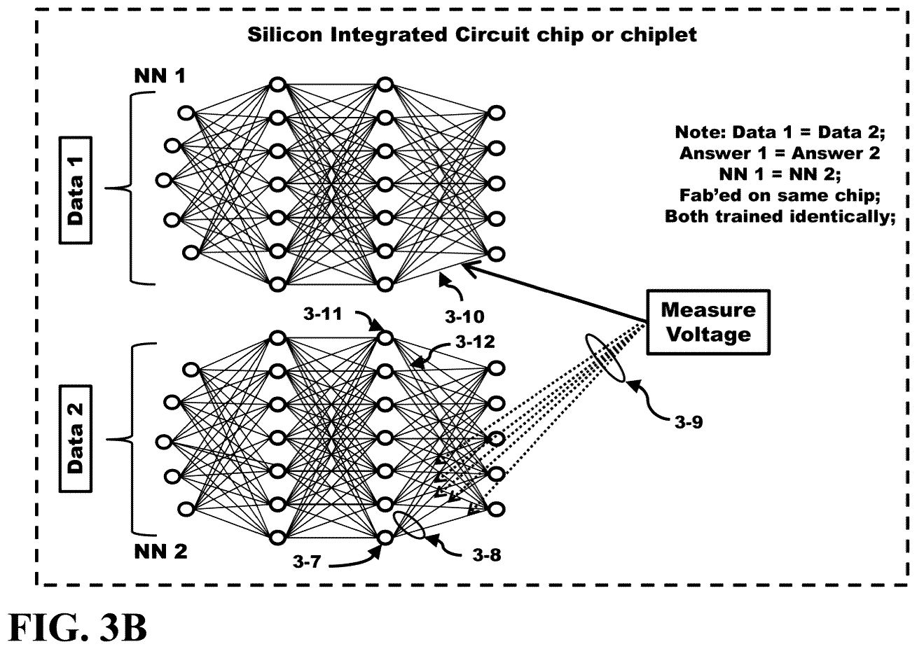

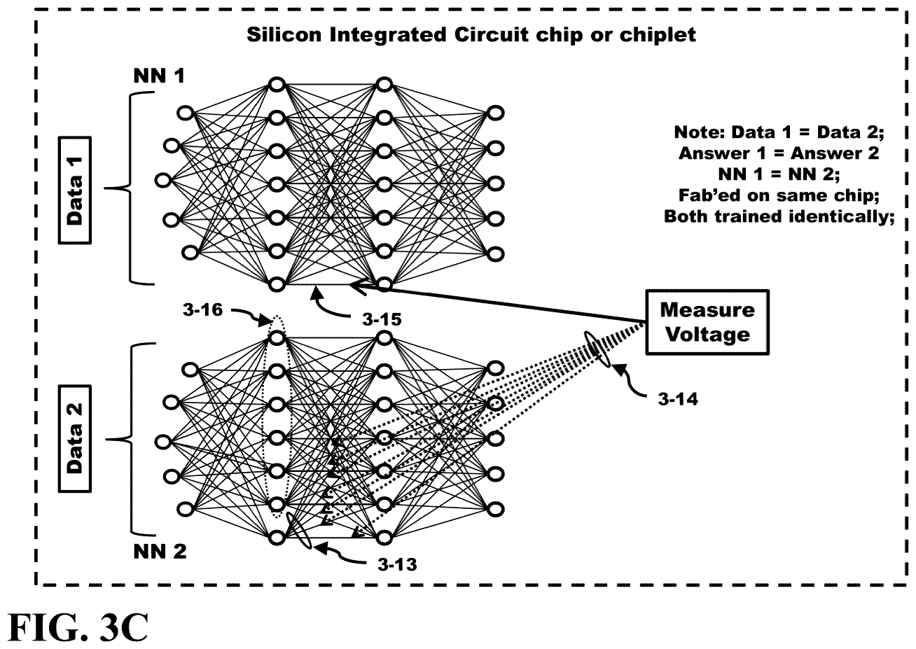

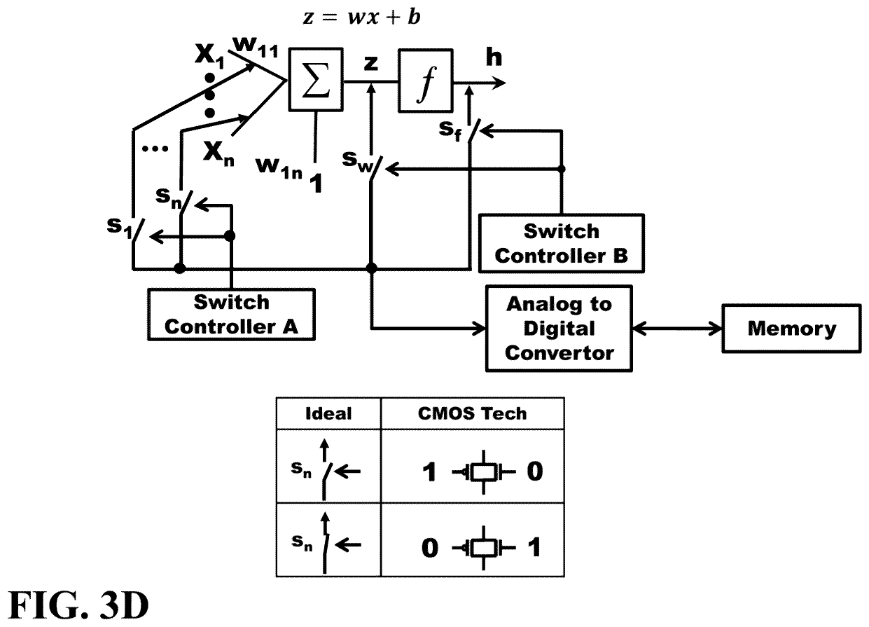

FIG. 3A illustrates two identical but smaller LLMs. The LLMs are implemented on the same die, where NN1=NN 2. Data 1 is equal to data 2. Answer 1 is equal to Answer 2. Both LLMs are trained exactly as the other. Transistor matching is used to make all circuit components identical. The issue is given that the LLMs are on the same die, how close will the corresponding values be? To begin a measurement, the weight 3-1 in NN1 is measured. The input and outputs layers of the two LLMs should match to each other because a known input and a known output is applied/extracted to/from the LLMs. Thus, when the voltage of the weight is measured going into node 3-2, there should be a similar voltage on one of the inputs to node 3-3 in NN 2. The weights going into node 3-3 are enclosed by the oval 3-4. If two LLMs are identical then one of the seven weights within the oval 3-4 should be a close match with the measured weight 3-1. Once it is found, then another weight going into node 3-2 in NN 1 is measured. Then the complementary weight is matched going into node 3-3. This process will continue until all weights going into node 3-2 matched the weights going into node 3-3. Once this is complete, a next pair of nodes 3-5 and 3-6 are chosen and the process of measuring the voltages is performed again. This measurement occurs for all the nodes in the output layers.

FIG. 3B illustrates two identical but smaller LLMs. The LLMs are implemented on the same piece of silicon, where NN1=NN 2. Data 1 is equal to data 2. Answer 1 is equal to Answer 2. Both LLMs are trained exactly as the other. Transistor matching is used to make all circuit components identical. The issue is given that the LLMs are on the same die, how close will the corresponding values be? One of the weights 3-10 in NN 1 is measured. Now we will search for a comparable weight within the weights of the oval 3-8 leaving the node 3-7 can be measured. In total there are 5 weights in the oval 3-8. However, if none of the voltages match, then another node, like 3-11 may need to be picked and the weight 3-12 may need to be measured.

FIG. 3C illustrates two identical but smaller LLMs. The LLMs are implemented on the same piece of silicon, where NN1=NN 2. Data 1 is equal to data 2. Answer 1 is equal to Answer 2. Both LLMs are trained exactly as the other. Transistor matching is used to make all circuit components identical. This illustrates measuring voltages in the hidden layers. Noise in the LMM may cause some of the voltages not to match exactly, but switch locations. The question remains: “If one has two identical LLMs, will the two always have the same internal voltages for the same answers?” It seems like in hidden layers, the order of the nodes can be mixed up while the LLM still produces a correct answer. The miss ordering is just the complexity of the system. At the input/output layers of the NN, the location of information is known. The information is partitioned into parts. There is a first part, a second part, etc. These input parts are applied to the NN in a particular order. When they are outputs, the information is given in parts, in a particular order. The input and output layers are physically related to the front and back end of the NN (input/output layer) as the NN is expecting information of prompts and providing a results.

However when we move into the hidden layers, there may be great diversity. It is possible you will have to search for more weights in the hidden layers until getting a match. This is unlike the input and output layer as they are identifiable and always in the same position. The hidden layers may alter the voltages between two identical NNs by rotating the values of groups within the matrix. Thus if one measures the voltage 3-15 in NN 1, then search in an identical location of the oval 3-13 in NN 2. However, the match may not be an exact match to one of the weights surrounded by the oval 3-13. Because of noise, the other 6 nodes identified by the oval 3-16 may need to be measured to find an equivalence value. One would expect a statistical variation of the values of the weights. If these NNs were fabricated in silicon there is a good chance that nearly identical NNs can be built.

FIG. 3D illustrates a multiple-summer that can be written or read. The switch controller A controls the switch S₁ through Sₙ. These switches can force a weight onto X₁ and Xₙ or read a weight from X₁ and Xₙ. The switch controller B controls the switch S_{w} and S_{f}. These switches can force a voltage onto z, the calculation of the sum of products, or h, non-linear result or read a voltage from them. The analog digital converter translates analog to digital for storage and the digital from the memory back into analog voltages. The switches can be a CMOS transmission switch which comprises a N-CHAN in parallel with a P-CHAN. The table illustrates the voltages that need to be applied to the gates to enable or disable the switch.

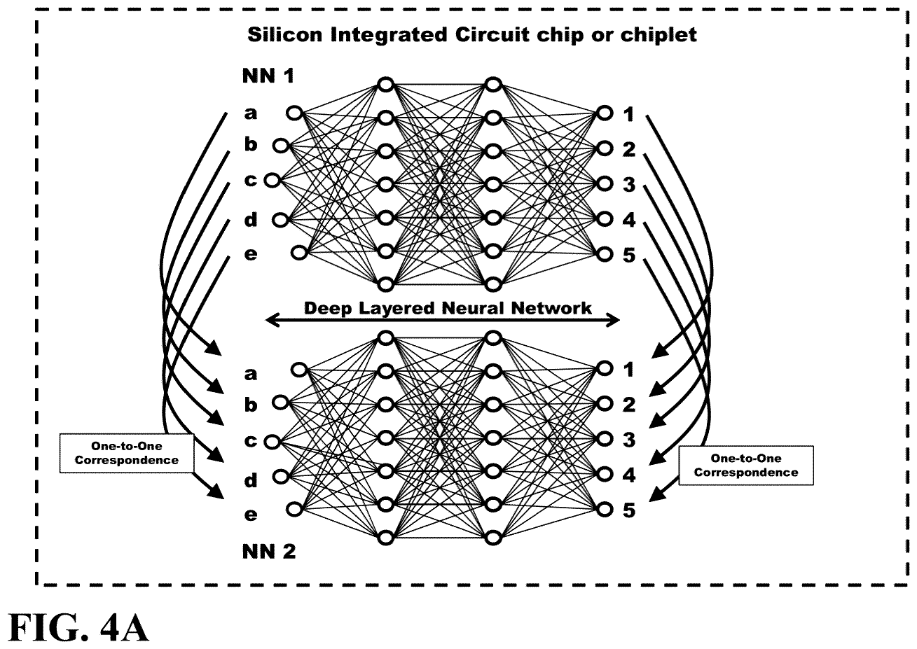

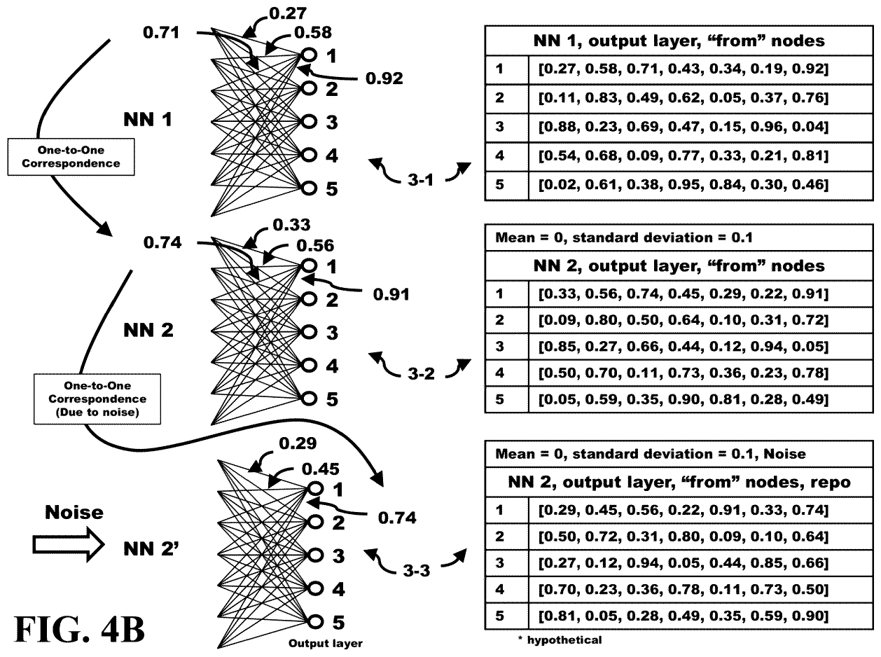

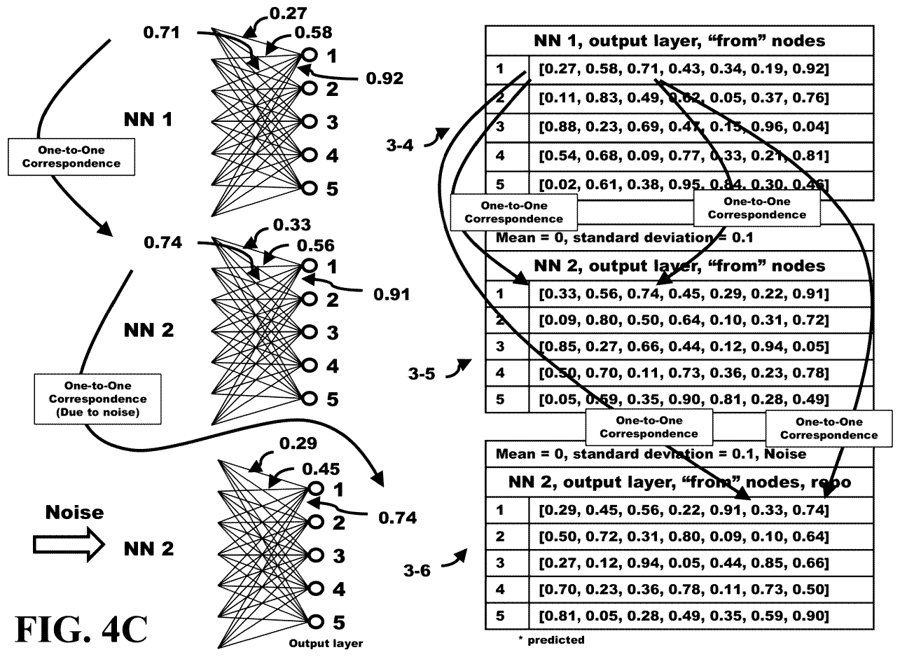

FIG. 4A illustrates the one-to-one correspondence of the input and output layer. The reason for the one-to-one correspondence is due to the way data is input to the NN and the way the data is taken from the output. The input is applied from node ‘a’ to node ‘e’, while the output is provided from ‘1’ to ‘5’. This arrangement is required to match the input data to a, b, c, d, and e and the output data matches 1, 2, 3, 4, and 5. Thus, these nodes ‘a-e’ and ‘1-5’ are permanent and should not change at all. Depending on the deep of the NN, the internal nodes may vary because of noise or just a normal distribution. To find the matching weights in the hidden layer, all groups may need to be measured to find the best match among the groups of weights.

FIG. 4B illustrates the hypothetical results of the possibility of noise affecting the values. The table and network 3-1 illustrates the measured values of the weights for all the 5 nodes of NN 1. For instance at node 1, a weight is 0.27, 0.58, 0.71. Comparing the table for node 1 we see 0.27, 0.58, 0.71, 0.43, 0.34, 0.19, and 0.92. Next, comparing the measured results of NN 2 for the case 3-2, at node 1, the measured weight has a mean=0 and a standard deviation of 0.1. The measurements are 0.33, 0.56, 0.74, 0.45, 0.29, 0.22 and 0.91. Note that the measured voltages are within a 0.1 deviation of each other. Assume noise has entered NN 2′ in 3-3. The weight 0.74 in NN2 matches the weight 0.74 in NN 2′. The NN 2′ may give a faulty result.

FIG. 4C provides more detail. In table 3-4, the first weight 0.27 shows the updated value in table 3-5 of 0.33 which is within 0.1 deviations of the 0.27 weight, Also note that in table 3-4 the weight 0.71 shows up as the weight 0.74 in table 3-5, again within 0.1 deviations. Note that the noise switched the order of the weights in table 3-6. The 0.27 becomes 0.33 and the 0.71 becomes 0.74.

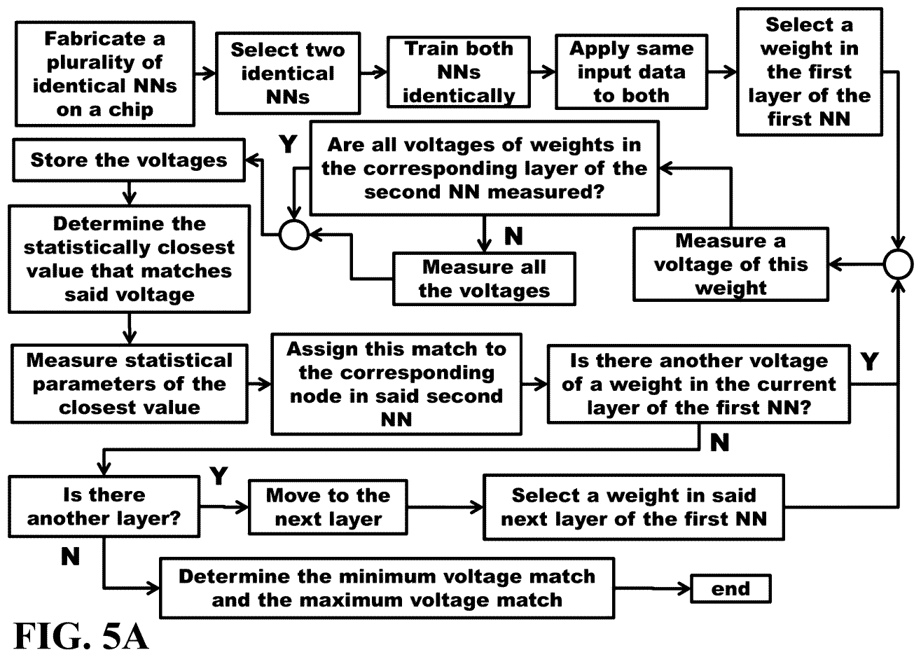

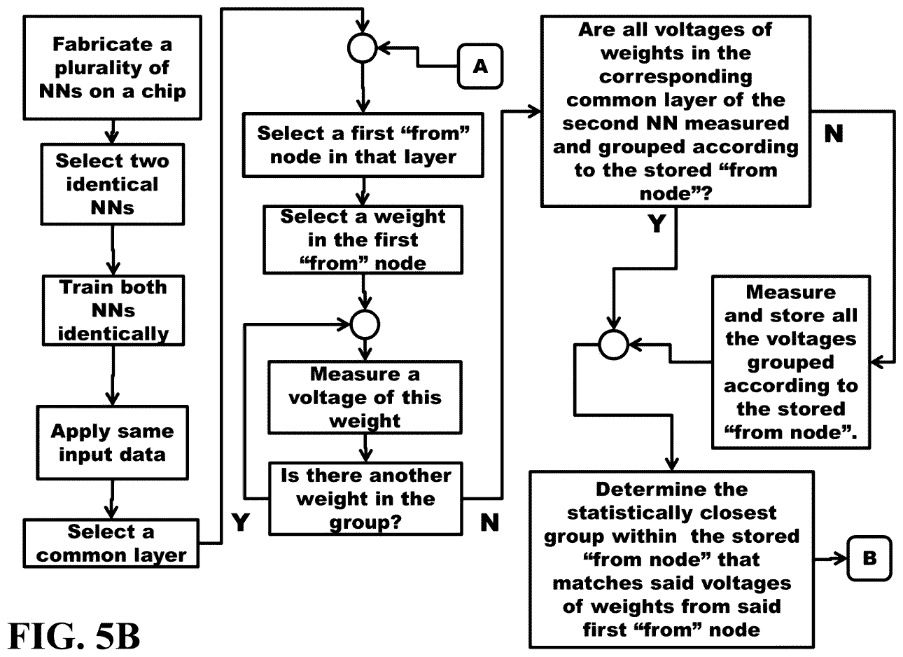

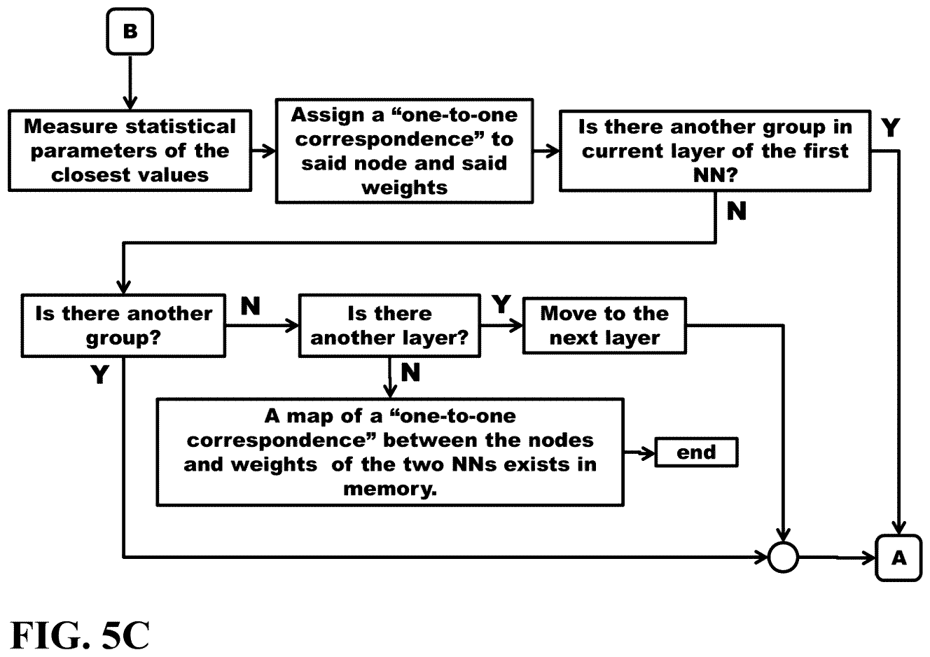

FIG. 5A illustrates a flowchart of fabricating two identical NNs on the same die, Both are trained identically, and both have the same inputs applied. First, measure the weights of the first layer in the first NN. Next, measure the voltages of weights in the corresponding layer of the second NN. After all voltages are measured, store then in memory. Next, determine the statistically closest values that match the said voltage. Then, measure the statistical parameters of the closest values. Assign this match to the corresponding node in said second NN. Is there another voltage of a weight in the current layer of the first NN? If yes, go back and measure the voltages, otherwise, check to see if there is another layer. Select a weight in this new layer of the first NN, then match the voltages with the same layer in the second NN. Once all layers have been measured been measured, determine the minimum voltage match and the maximum voltage match.

FIG. 5B presents another flowchart. First, fabricate a plurality of NNs on a chip and select two identical NNs. Train both identically with the same input data, select a common layer and select a first “from” node in that layer. Select a weight in the first “from” node and measure the voltage of this weight. Is there another weight in the group, then measure that weight too. Are all voltages of weights in the corresponding common layer of the second NN measured and grouped according to the stored “from node”? If not, measure and store all the voltages grouped according to the stored “from node. Otherwise, determine the statistically closest group within the stored “from node” that matches said voltages of weights from said first “from” node. Move to B, to measure statistical parameters of the closest values. Then, assign a “one-to-one correspondence” to said node and said weights. If there another group in current layer of the first NN? Go to step A and continue, otherwise if there is another group, move to A. If not, is there another layer? Move to the next layer and proceed to A. Otherwise, if there are no more layers, make a map of a “one-to-one correspondence” between the nodes and weights of the two NNs as they exist in memory.

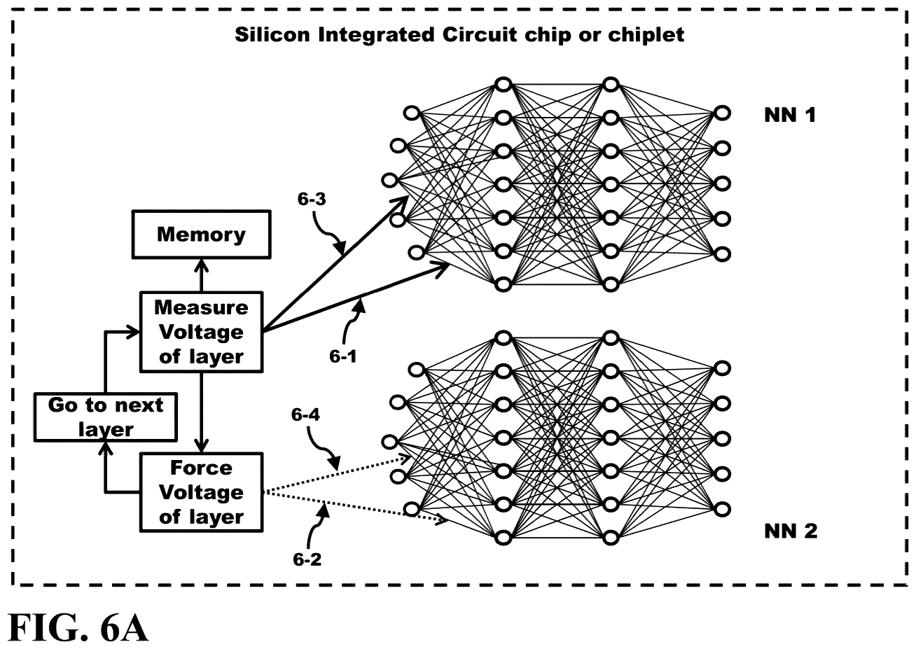

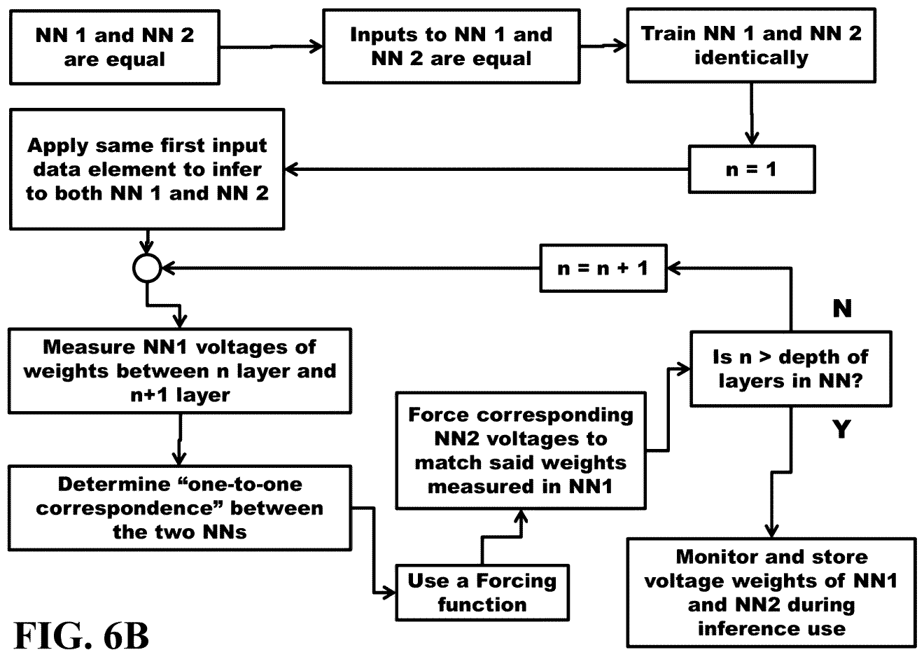

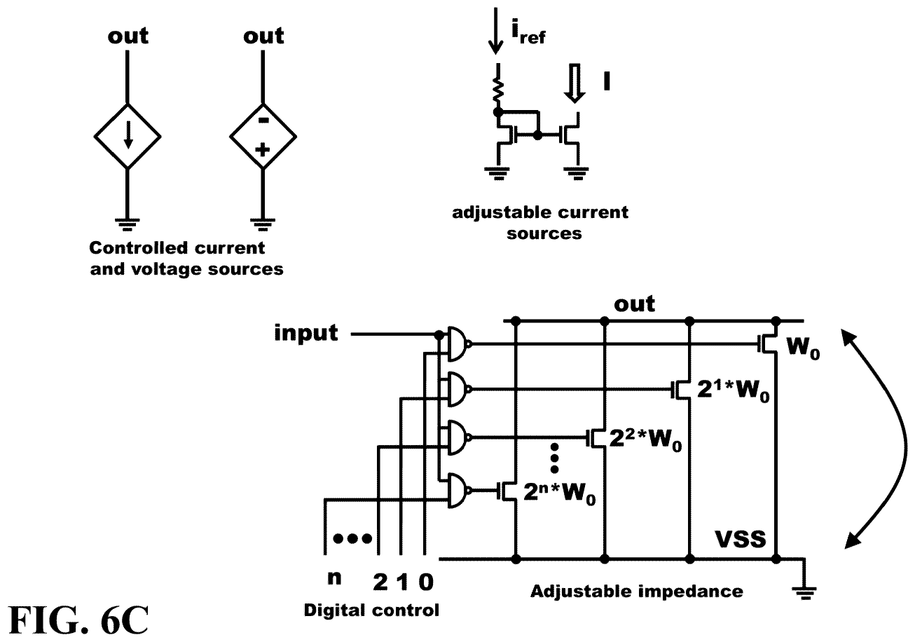

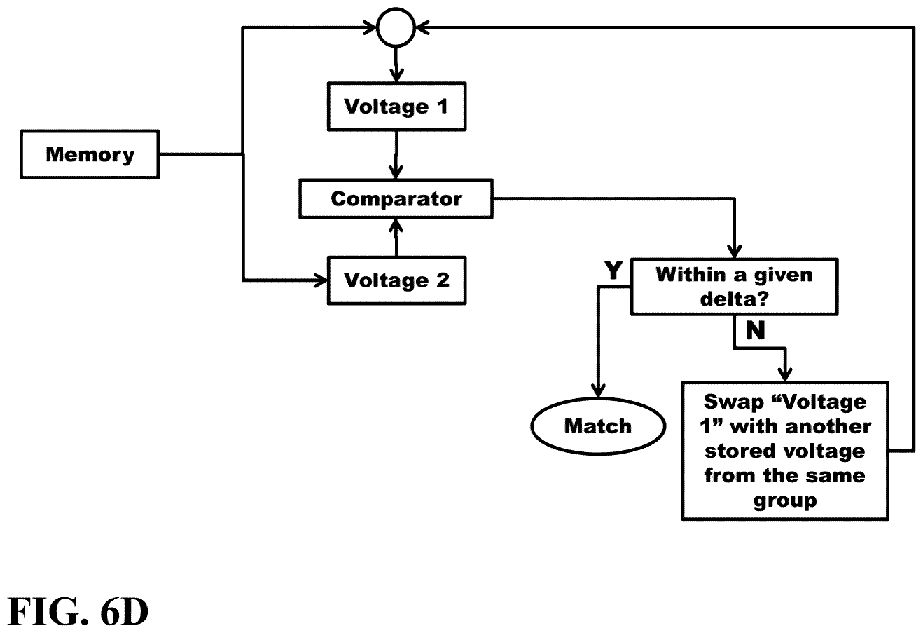

FIG. 6A illustrates a method of measuring the weights in a first NN 1 and string then into memory. This voltage will then be forced on to the voltage on a duplicate node in a second identical NN 2, where both NNs are fabricated in a single silicon chip. For instance, the voltage of 6-1 and 6-3 are measured and stored in memory. This voltage is used to force the voltages of 6-2 and 6-4 in the NN 2, respectively. All weights in all layers are measures and forced.

FIG. 6B is a flowchart that forces a second NN to have the voltages of a first NN. There are two NNs and they are fabricated together in silicon. The two NN are identically trained and starting at layer n=1, the same input data is applied to both NNs. The weights between layers n=1 and n=2 of the NN 1 is measured. Similarly, the NN 2 is measured between layers n=1 and n=2 to find the one-to-one correspondence. Once the one-to-one-correspondence is determined, a forcing function is used to adjust the voltage of the NN 2 to match the voltage of a corresponding point. After this layer (n=1) is completed, the next layer (n=2) is called. The process continues in the same manner until the next layer (n=3) is called. The ‘n’ increases in value till the layers run out. During identical inference, the voltages of the weights of NN1 and NN2 are monitored and stored during inference use.

FIG. 6C illustrates some examples of forcing functions. A forcing function can be added in series with the weight. This allows an accurate control of the voltage of the weights. Some examples of forcing functions are a controlled current and controlled voltage sources. Another is an adjustable current source which can continuously adjust the current. As the current i_{ref} is altered, it linearly adjusts the current ‘I“. And, finally, a digital adjustable impedance comprised of a number of digitally weighted branches can be enabled by the digital control applied to the NAND gates. The digital control adjusts the amount of transistor width that is enabled. The 'input’ node enables those NAND gates that are enabled by the digital control.

FIG. 6D depicts a flowchart for swapping voltages when outside a given delta. All voltages from two identical NNs were measured and stored in memory. After forming a one-to-one correspondence, then all weights should match within a given tolerance.

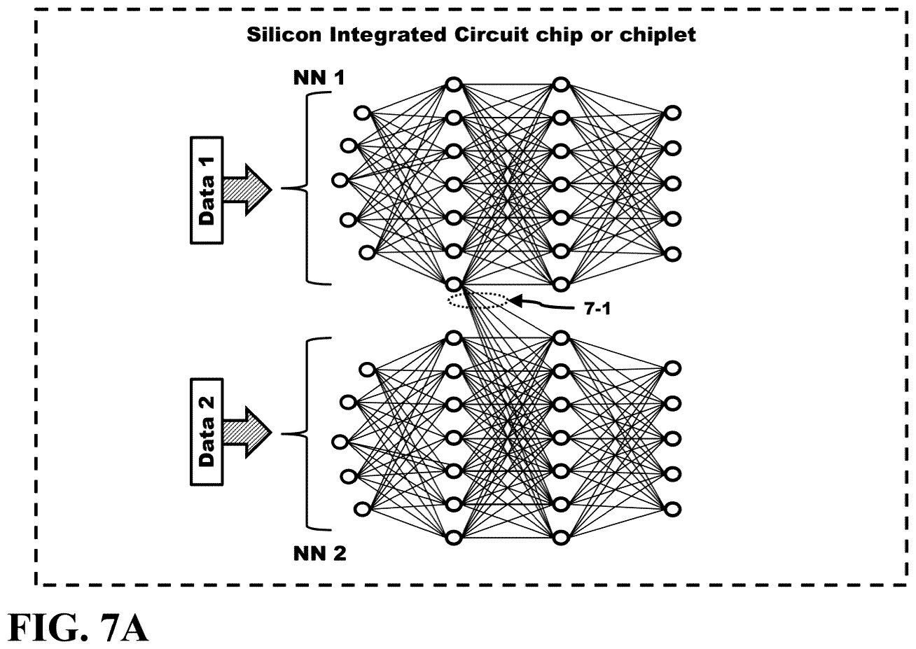

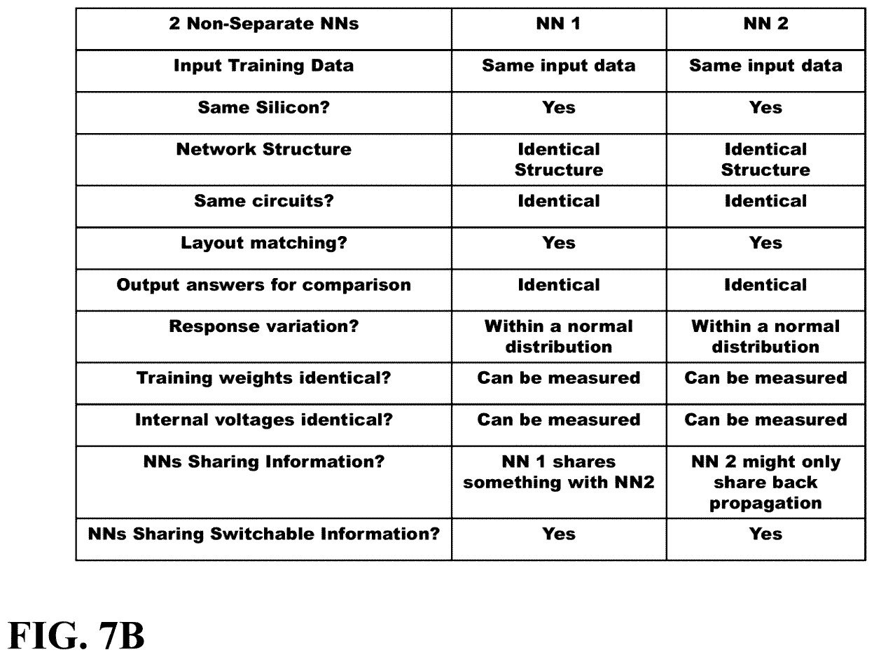

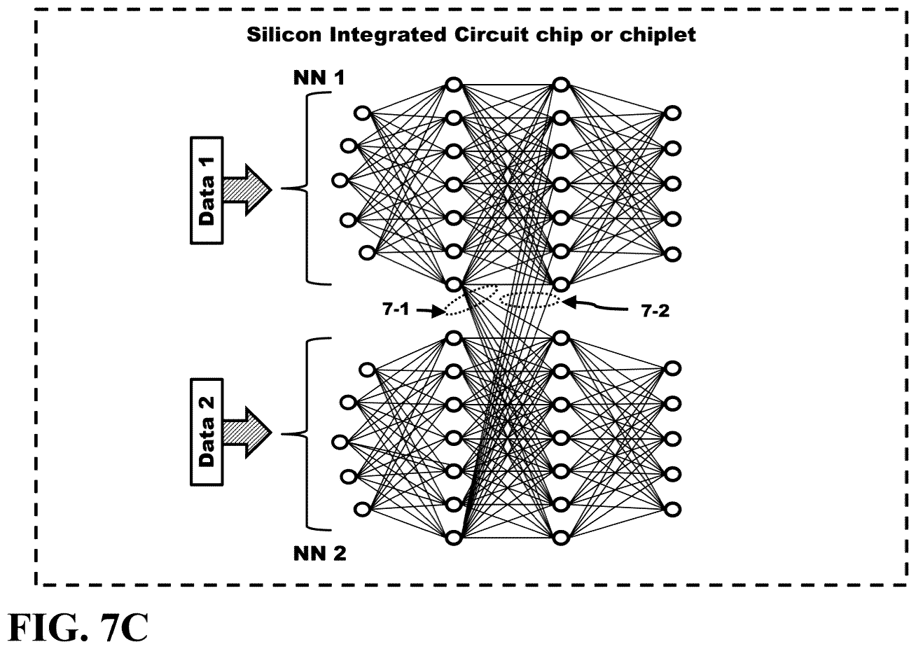

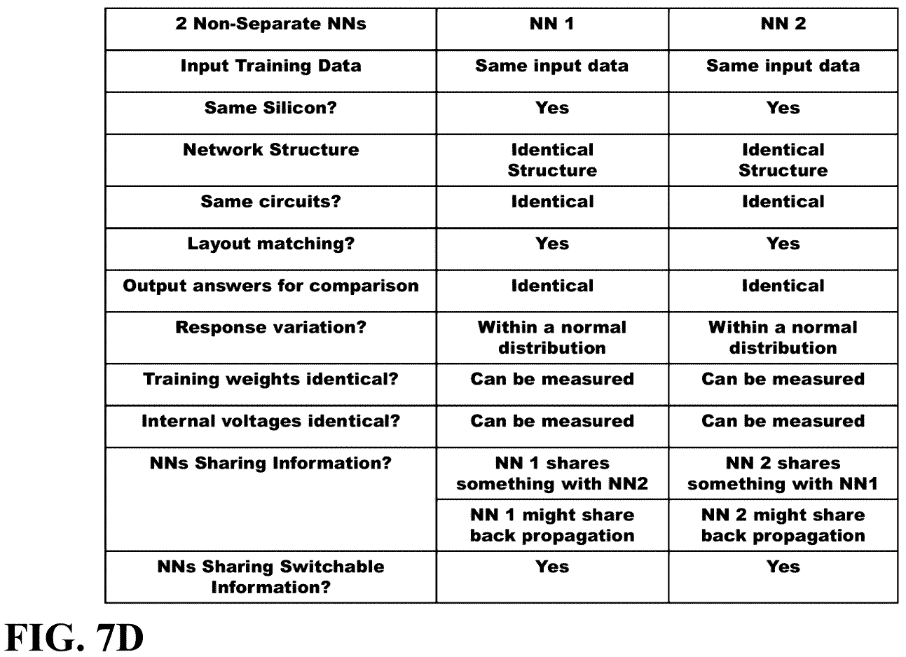

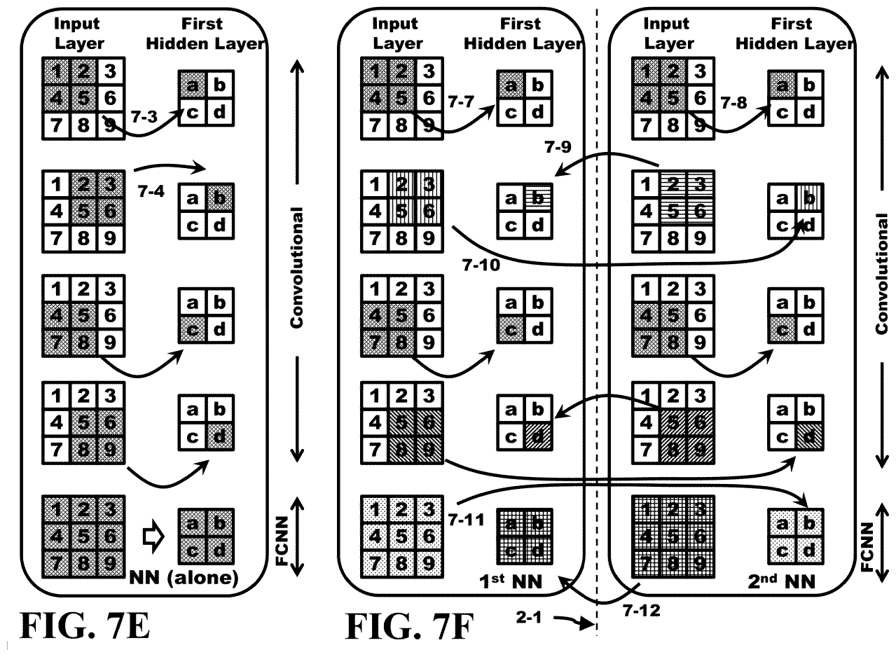

FIG. 7A illustrates an NN 1 communicating with an NN 2 via the weights 7-1 when the connection 7-1 is enabled. These NNs are otherwise identical, both formed on the same silicon, trained the same way, same input data, but the NN 1 can enable the weights 7-1 when the NN 1 desires. Note that the NN 2 does not communication directly with NN 1. This type of a configuration allays NN 1 to control or provided additional information to NN 2 when desired. A switchable connection is one that demonstrates a connection at a first instant and eliminates the connection at another instant. In some cases, the elimination does not affect the operation of the remaining circuitry.

FIG. 7B depicts a table comparing the two NNs of FIG. 7A. In this embodiment, both NNs were trained using the same data. Both NNs were fabricated on the same silicon die, both have the same network structure, both use the same circuits, and the same layout matching techniques were used. If the two NNs have been matched perfectly, then the real numbers of the voltages should be within a normal distribution. All voltages can be measured by using a switch which can tap into a circuit and transfer its voltage. A switchable connection is one that demonstrates a connection at a first instant and eliminates the connection at another instant. In some cases, the elimination does not affect the operation of the remaining circuitry. In addition, the NN 1 does have some switchable connections to the NN 2. A switchable connection is one that demonstrates a connection at a first instant and eliminates the connection at another instant where the elimination makes the connection disappear. This switchable connection when enabled allows NN1 to share some information with the NN 2. NN2 may share back-propagation information with NN1.

FIG. 7C illustrates an NN 1 communicating with an NN 2 via the weights 7-1 when the connection 7-1 is enabled by NN 1. Also, NN 2 communicating with an NN 1 via the weights 7-2 when the connection 7-2 is enabled. These NNs are otherwise identical, both formed on the same silicon, trained the same way, same input data, but the NN 1 can enable the weights 7-1 when the NN 1 desires or the NN 2 can enable the weights 7-2 when the NN 2 desires. Note that the NN 2 can communication directly with NN 1 and vis versa. This type of a configuration can share information between the NNs.

FIG. 7D depicts a table comparing the two NNs of FIG. 7C. In this embodiment, both NNs were trained using the same data. Both NNs were fabricated on the same silicon die, both have the same network structure, both use the same circuits, and the same layout matching techniques were used. If the two NNs have been matched perfectly, then the real numbers of the voltages should be within a normal distribution. All voltages can be measured by using a switch which can tap into a circuit and transfer its voltage. A switchable connection is one that demonstrates a connection at a first instant and eliminates the connection at another instant. In some cases, the elimination does not affect the operation of the remaining circuitry. In addition, the NN 1 does have some switchable connections to the NN 2 as well as a switchable connection n between NN 2 to NN 1. Either of these two switchable connections when enabled allows NN 1 to share some information with the NN 2 or for NN 2 to share information with NN 1. NN 2 may share back-propagation information with NN 1 and NN 1 may share back-propagation information with NN 2.

FIG. 7E illustrates a single NN using the technique of convolutional decoding to recover more spacial data. For example, 1, 2, 4, and 5 will share weights with node a 7-3. And, 2, 3, 5, and 6 will share weights with node b 7-4. For the fully connected neural network, shown on the bottom, all nodes of one layer are connected to all nodes in the next layer.

FIG. 7F depicts two separate NNs that can selectively connect layers of different NNs together. Note in the fully connected neural network, as illustrated on the bottom, the input layer of the 1^{st} NN connects to the first hidden layer in the 2^{nd} NN. Summarily, the input layer of the 2^{nd} NN connects to the first hidden layer in the 1^{st} NN. The convolution may be shared between the two NNs. This is shown as paths 7-9, 7-10, 7-11 and 7-12. Or, the convolution may be shared within just one NN, as illustrated in 7-7, or 7-8. When information is shared between two NNs, the ability to solve problem generally improves.

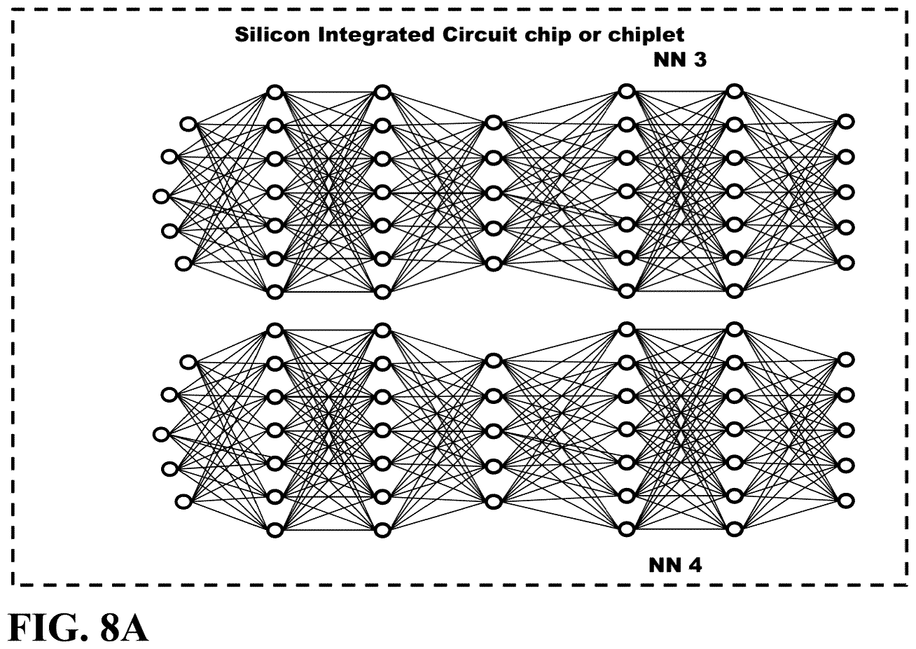

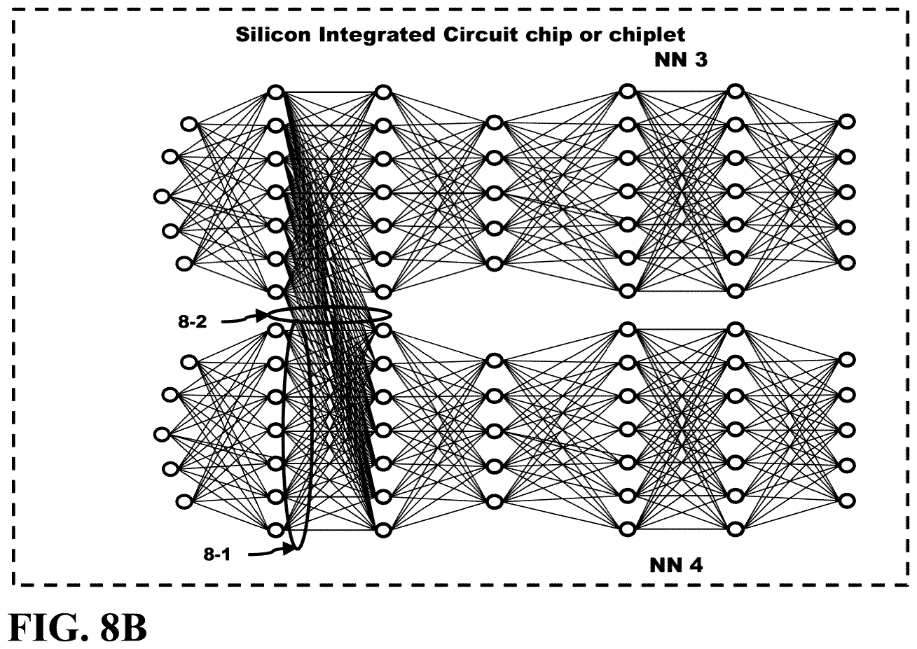

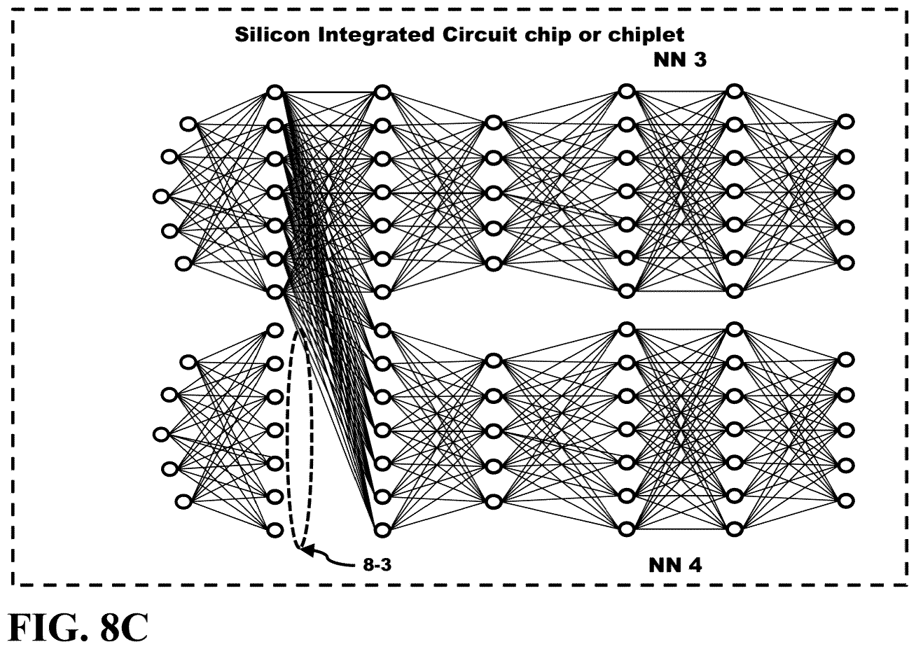

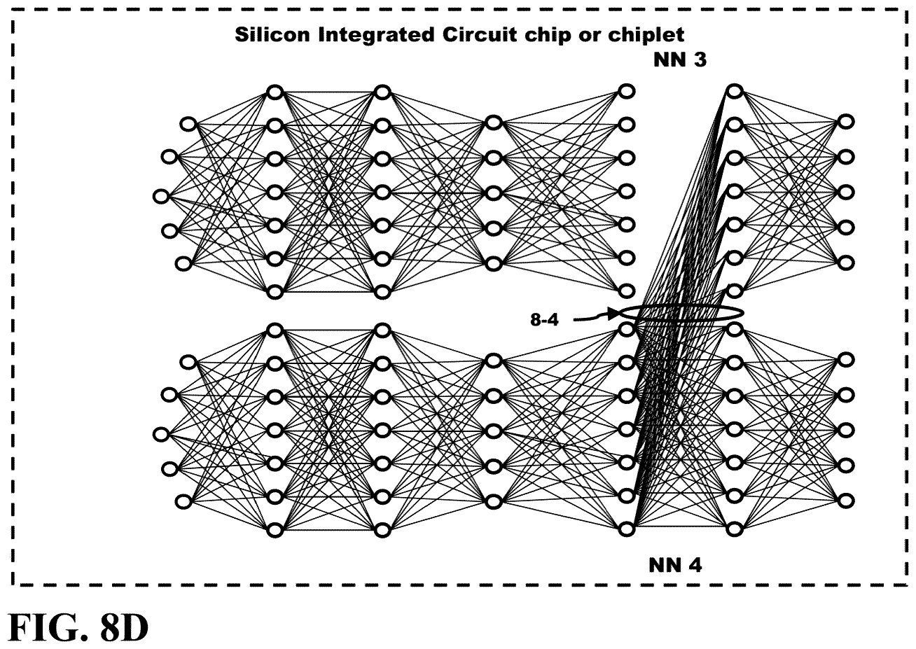

FIG. 8A illustrates two identical NNs: NN 3 and NN 4. These are fabricated in the same piece of silicon. Everything is matched: the two NNs operate equivalently. A switchable connection is one that demonstrates a connection at a first instant and eliminates the connection at another instant. In some cases, the elimination does not affect the operation of the remaining circuitry. Such a switchable connection is illustrated in FIG. 8B. The NN 3 provides a fully connected switchable connection neural network 8-2 in only the second layer from NN 3 to NN 4. Note that the original inputs of 8-1 are also added to the interconnects, Thus, NN 4 is receiving two fully connected inputs. A switchable connection is one that demonstrates a connection at a first instant and eliminates the connection at another instant. In some cases, the elimination does not affect the operation of the remaining circuitry.

FIG. 8C depicts one of the fully connected neural network weights removed 8-3. The rest of the neural network only follows the functioning of the upper NN. In FIG. 8D, NN 4 provides a switchable connection to NN 3, In addition, the original path of the NN 3 has been terminated.

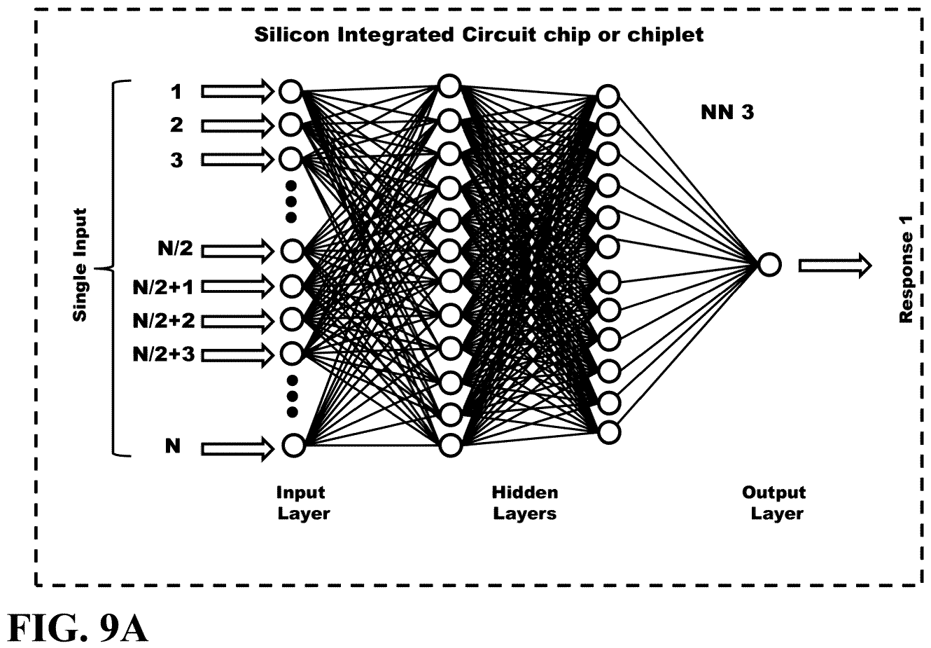

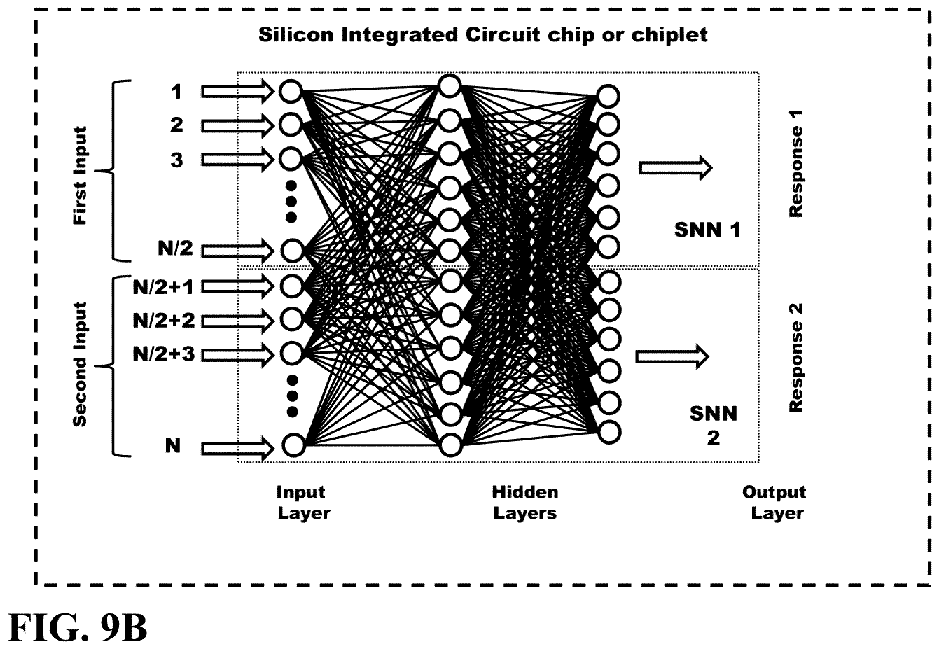

FIG. 9A illustrates a fully connected NN that has been trained with a signal “n” input tokens and a single analog voltage output. The NN is then partitioned into two equal parts as shown in FIG. 9B. The two NNs are retrained. The two NNs each has a prompts; one from 1 to N/2 and the second from N/2+1 to N. In addition, each NN has their own output.

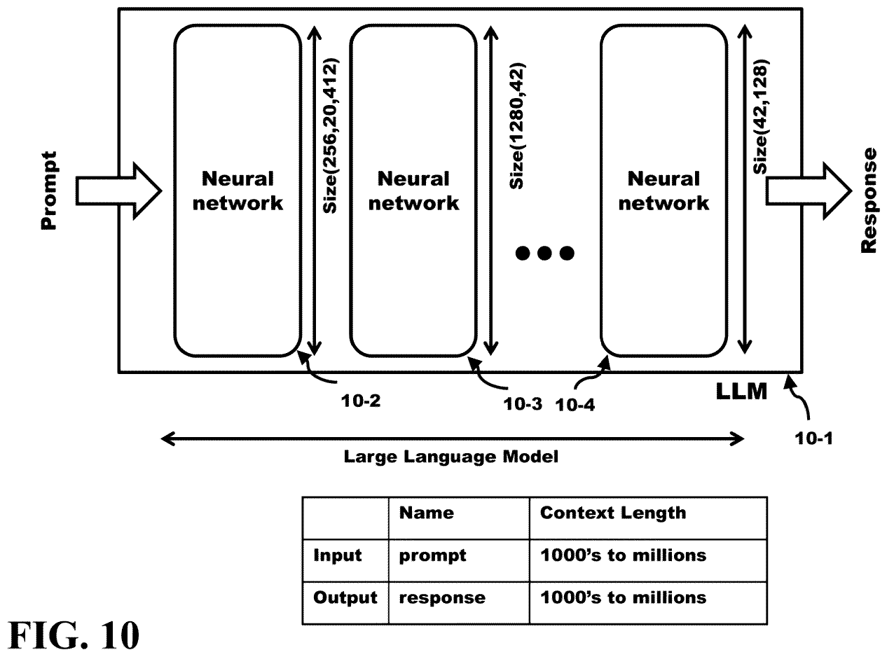

Large Language models (LLM) 10-1 are built from NNs. FIG. 10 illustrates a LLM. The LLM comprises several neural networks: one 10-2 with size (256, 20, 412), another 10-3 with size (1280, 42), a number of intermediate sizes, then the final one 10-4 with size (42, 128). The input prompt can range from 10's to millions of tokens, Similarly, the response to the query can range from 10's to millions of tokens.

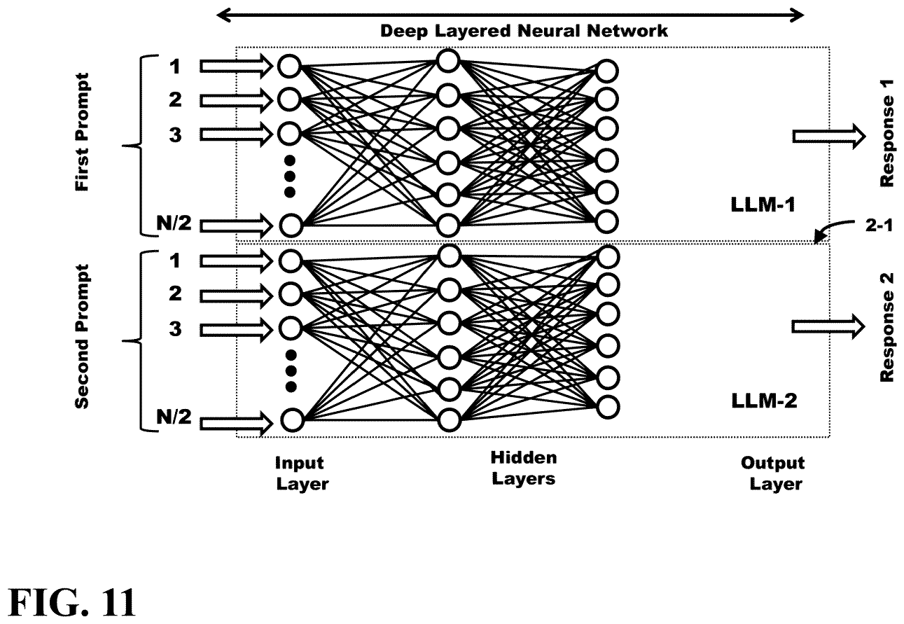

FIG. 11 illustrates two identical LLM-1 and LLM-2. The input to the LLM is a token length of N/2. The output of the LLMs has two responses. Note line 2-1, where there are no weights or connections crossing the line 2-1 between the two LLMs. These two LLMs are independent of each other.

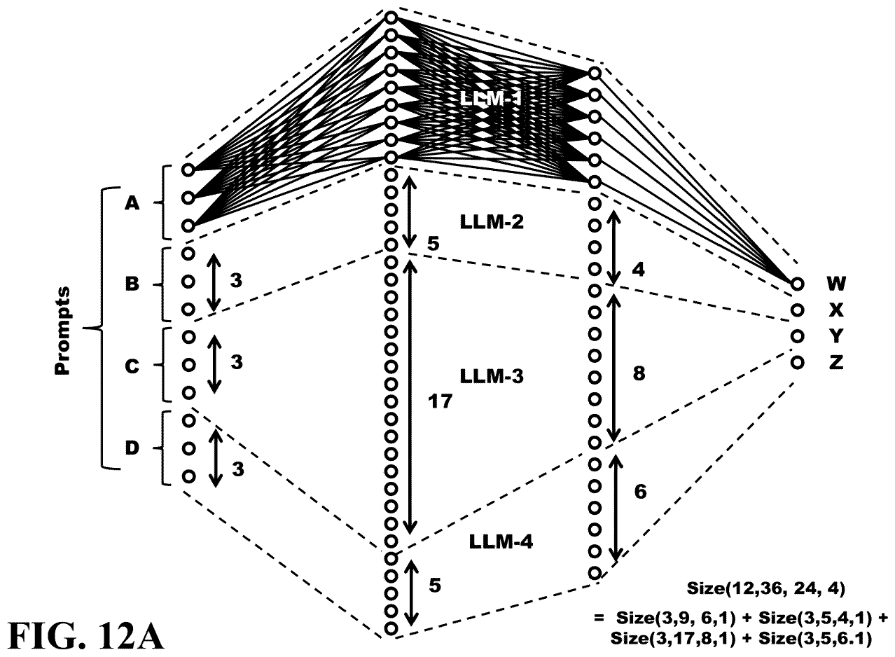

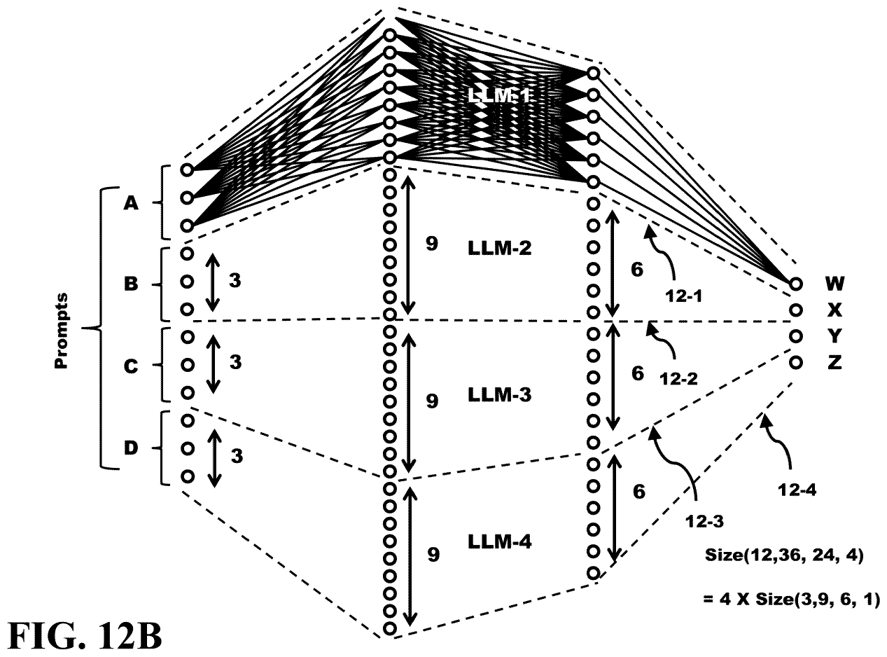

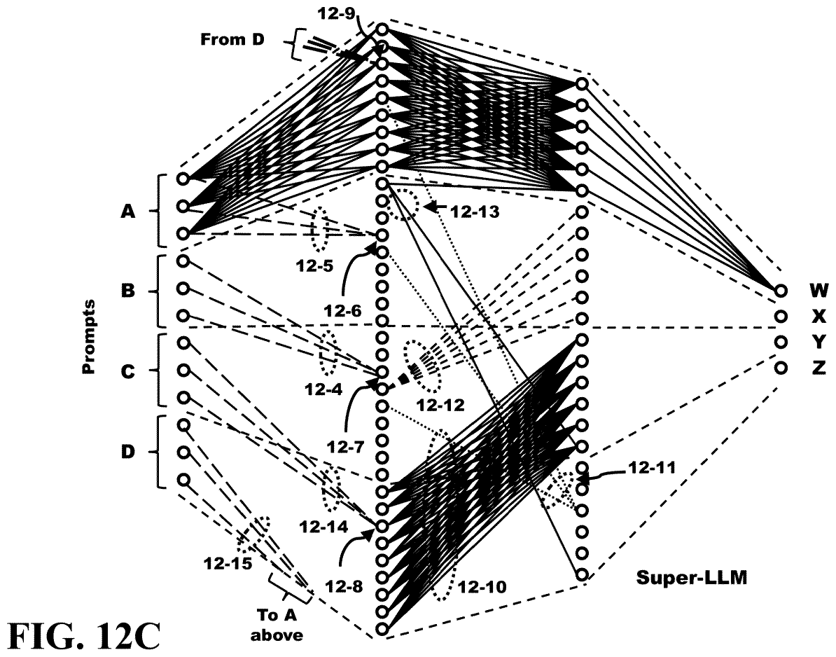

FIG. 12A presents a 4 LLM arranged with different number of nodes per layer. The LLMs start with an input layer of 3, 3, 3 and 3, the next layer 9, 5, 17, and 5, the next layer 6, 4, 8, and 6. The final layer is 1, 1, 1, and 1. FIG. 12B depicts the 4 LLMs arranged evenly at all layers. The input row is 3, 3, 3, and 3. The first layer is 9, 9, 9, and 9. The next layer is 6, 6, 6, and 6. And the final is 1, 1, 1, and 1. Note that no wires or weights cross the lines 12-1, 12-2 or 12-3.

FIG. 12C shows the 4 LLMs of FIG. 12b with the sharing of weights between the different LLMs. LLM A shows a fully connected LMM. Some of the inputs of A 12-5 are also applied to one of the nodes 12-6 in the hidden layer of B. Some of the inputs of B 12-4 are also applied to one of the nodes 12-7 in the hidden layer of C. Some of the inputs of C 12-14 are also applied to one of the nodes 12-8 in the hidden layer of D. Some of the inputs of D 12-15 are also applied to one of the nodes 12-9 in the hidden layer of A. Some of the inputs of D 12-15 are also applied to one of the nodes 12-8 in the hidden layer of D. There are other cross connections not mentioned but illustrated. Because the LLMs are a switchable connection where A switchable connection is one that demonstrates a connection at a first instant and eliminates the connection at another instant. In some cases, the elimination does not affect the operation of the remaining circuitry. This is called a Super-LLM. This Super LLM has 4 input prompts and 4 responses, but because of the interconnect; the LLMs share information to improve the response of the Super-LLM.

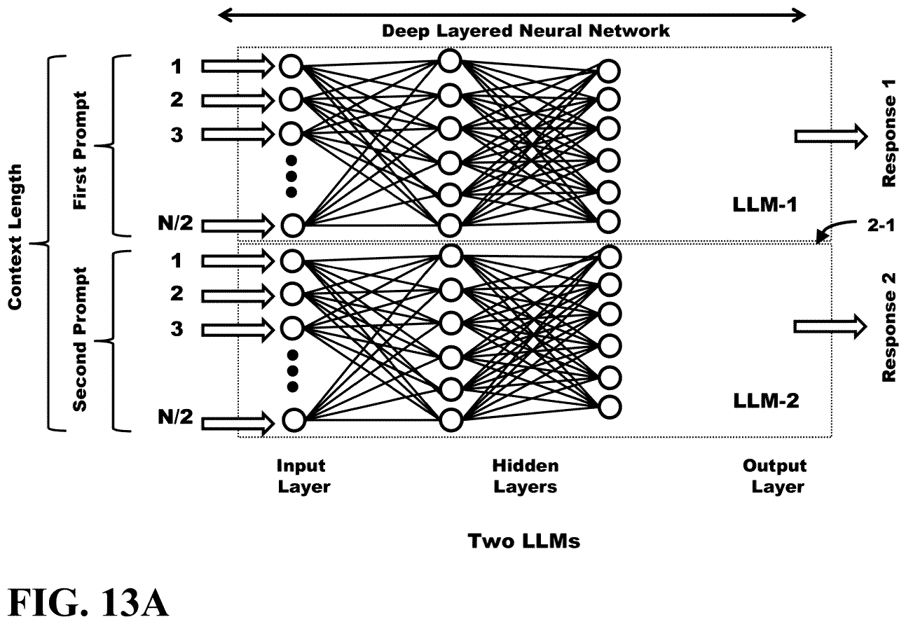

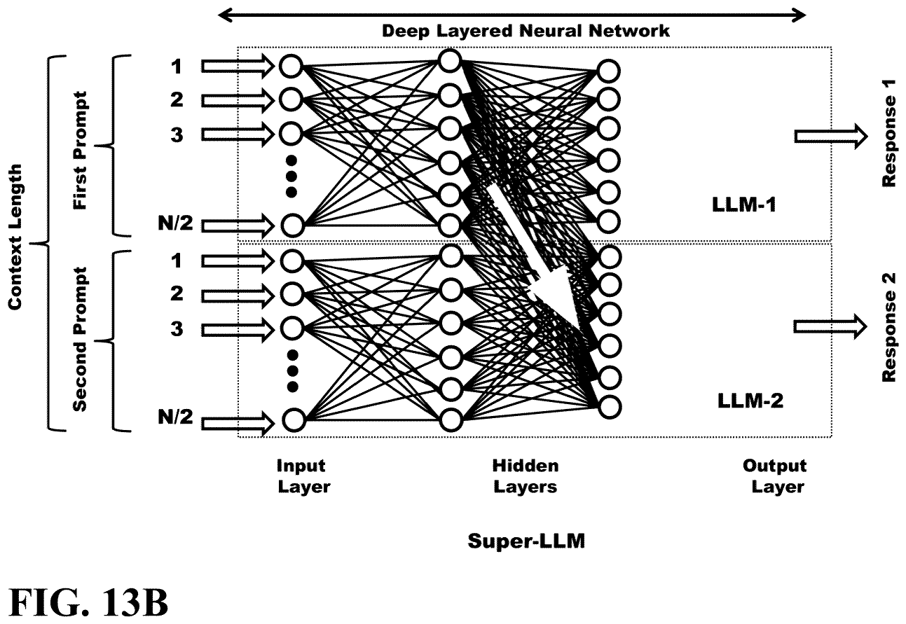

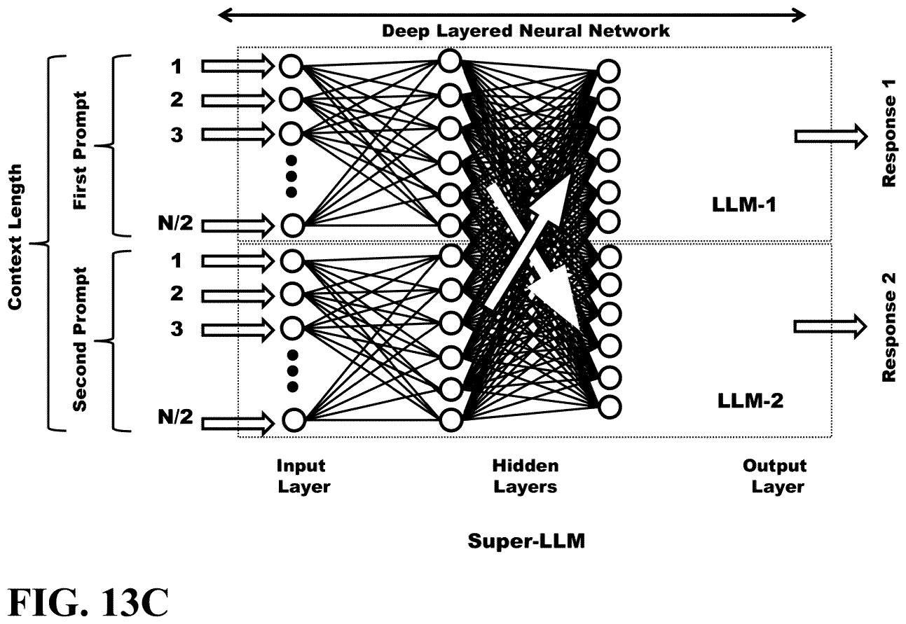

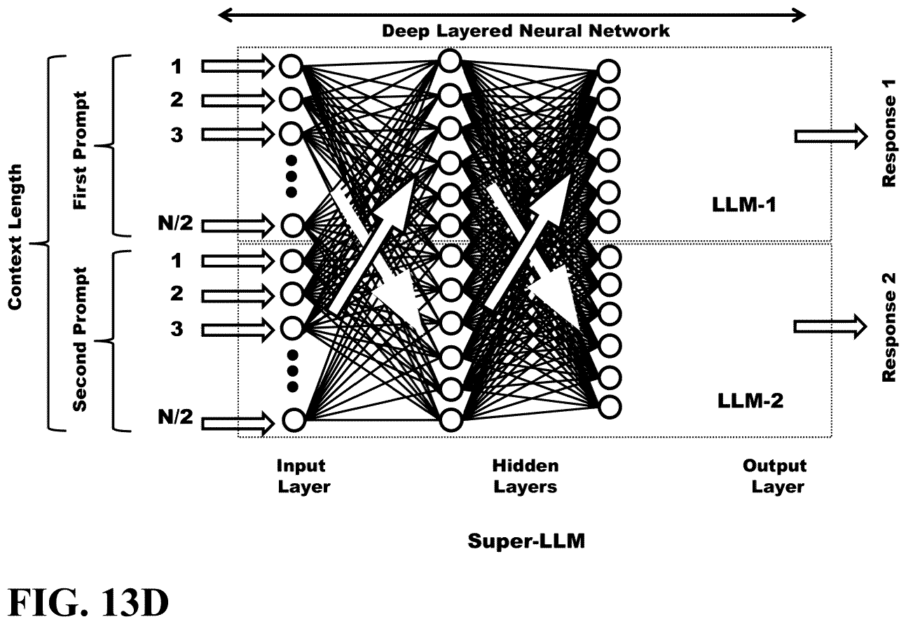

FIG. 13A illustrates two identical LLM-1 and LLM-2. The input to each of the LLMs is a token length of N/2. The output of the LLMs has two responses. Note line 2-1, where there are no weights or connections crossing the line 2-1 between the two LLMs. These two LLMs are independent of each other.

FIG. 13B depicts the first hidden layer of LLM-1 totally switchable connected to final nodes of LLM-2 as illustrated by the white arrow. A switchable connection is one that demonstrates a connection at a first instant and eliminates the connection at another instant. In some cases, the elimination does not affect the operation of the remaining circuitry. LLM-2 becomes more powerful since it is receiving a large amount of information. FIG. 13C depicts the first hidden layer of LLM-2 totality switchable connected to final nodes of LLM-1 as illustrated by the second white arrow. A switchable connection is one that demonstrates a connection at a first instant and eliminates the connection at another instant. In some cases, the elimination does not affect the operation of the remaining circuitry. LLM-2 and LLM-1 becomes more powerful since both are receiving a large amount of information. FIG. 13D makes a fully connected LLM-1 to LLM-2 and a fully connected LLM-2 to LLM-1. This Super-LLM used a fully connected NN and has two input prompts along with two responses.

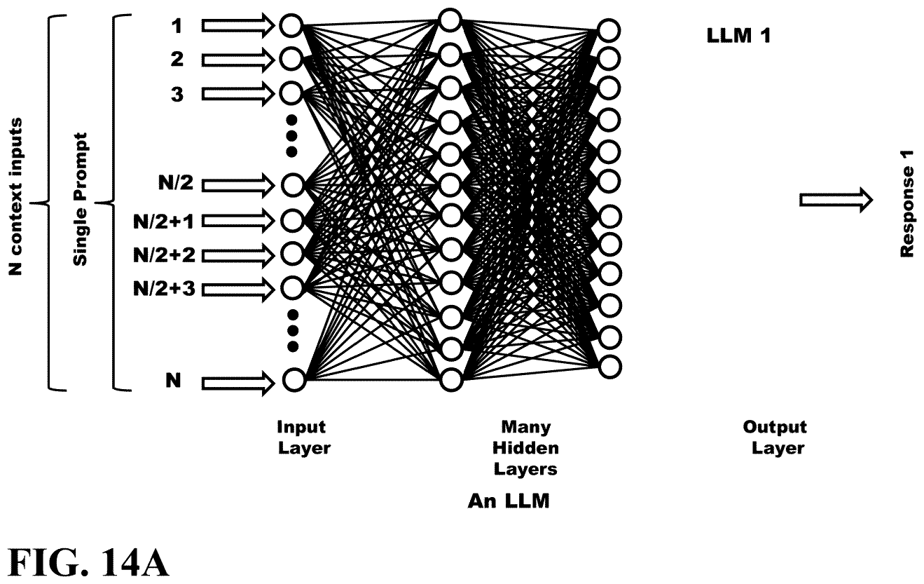

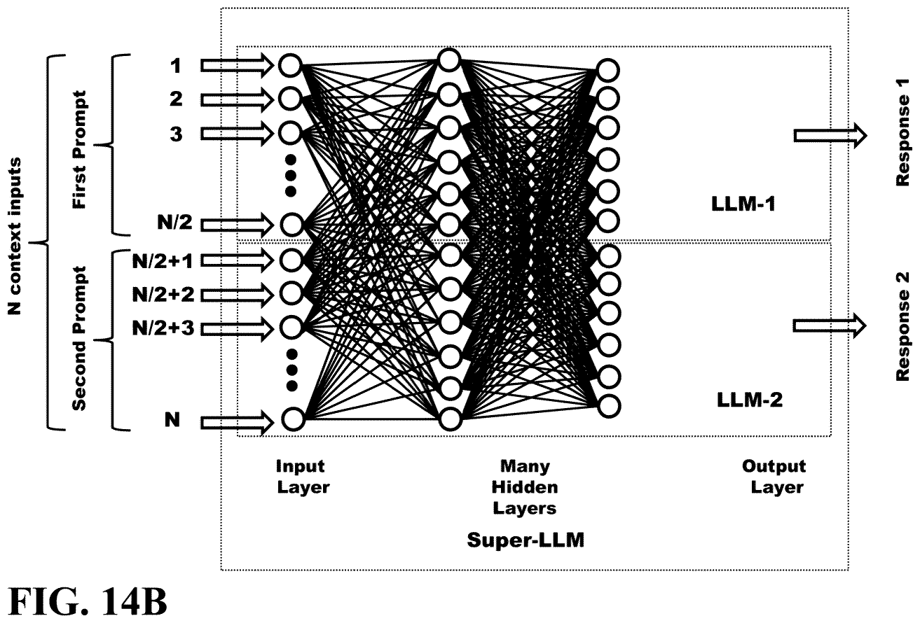

FIG. 14A is a single LLM with a N content size with a single response. This is very much a conventional LLM. The LLM is further trained assuming the single prompt has been halved into two prompts as illustrated in FIG. 14B. Each prompt generating its own response. Once the training is complete, the two LLMs become a Super-LLM.

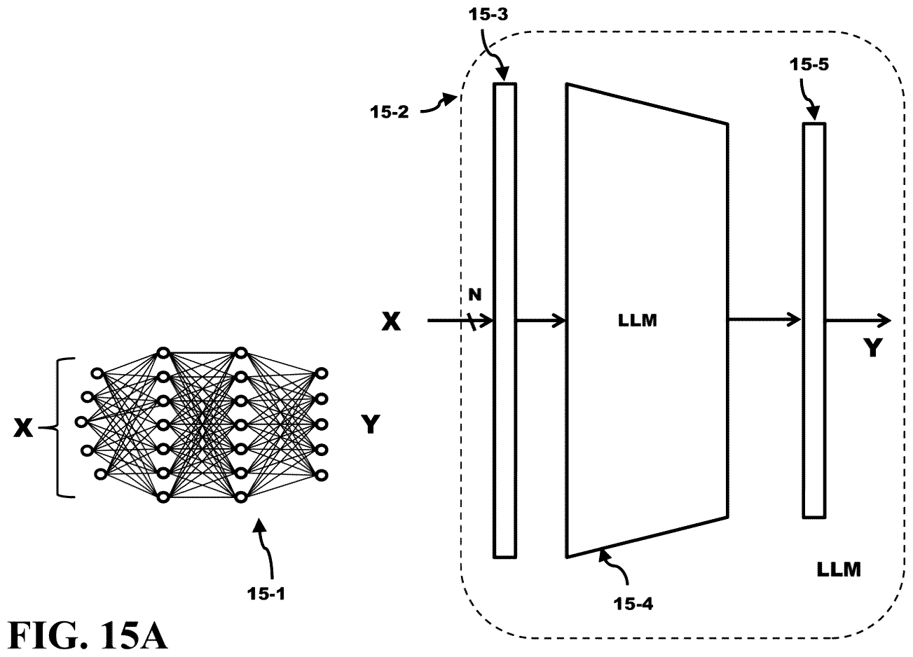

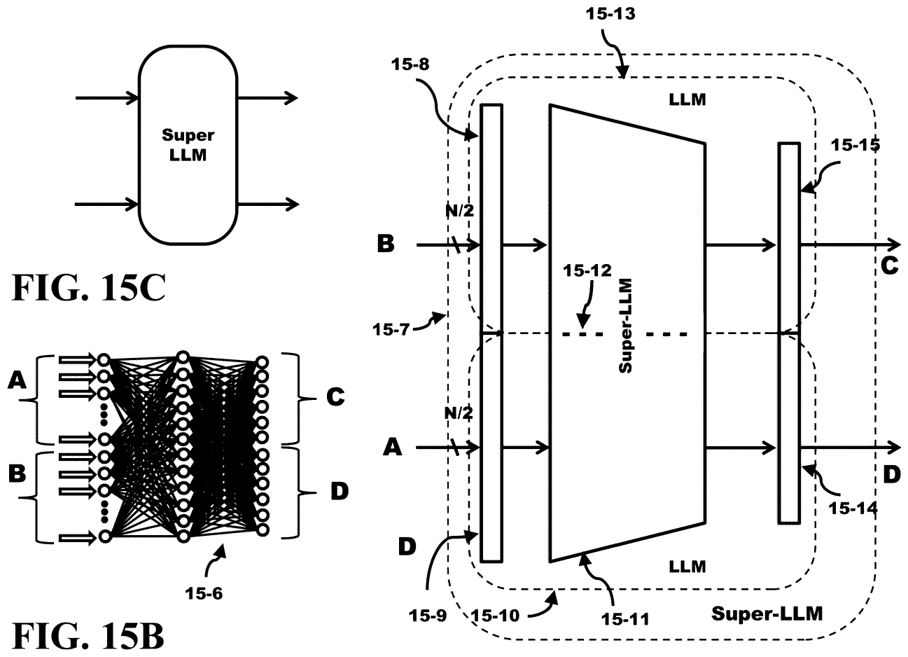

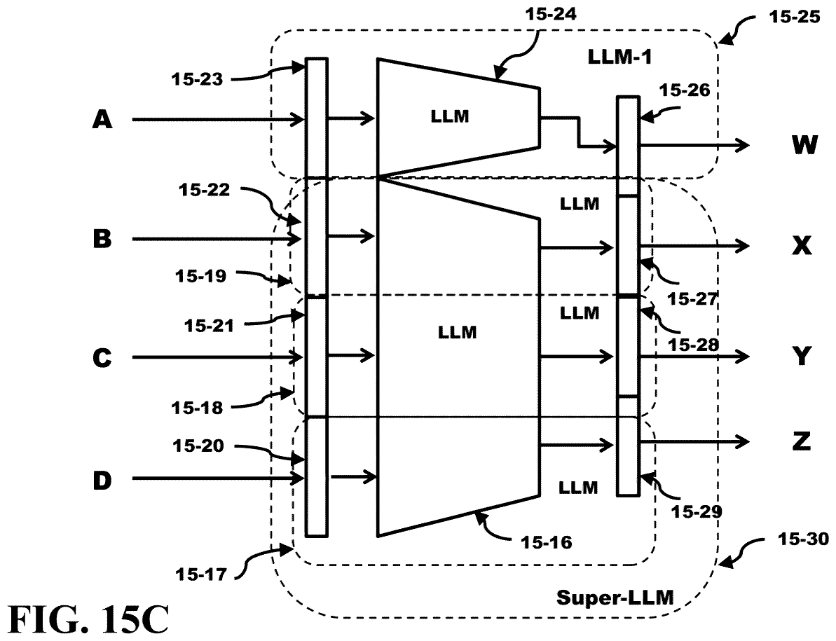

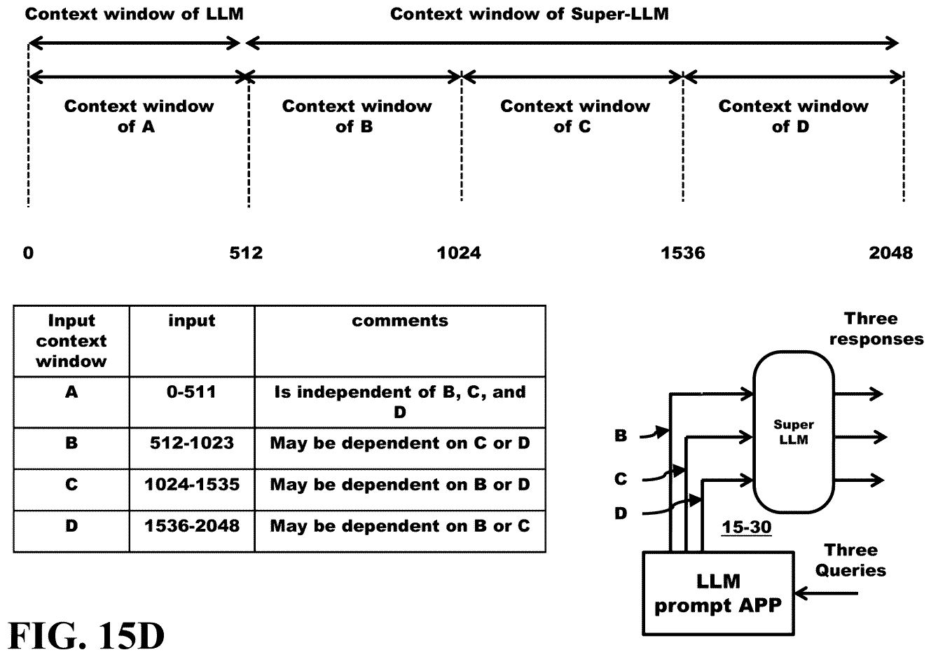

FIG. 15A illustrates a LLM 15-1. The LLM model is presented as 15-2. The input layer is 15-3 with a context widow of N. This feeds into the LLM 15-4 and the response is provided at the registers 15-5.

FIG. 15B illustrates a Super-LLM 15-7. It has two input prompts A 15-9 and B 15-8, and two output responses C15-15 and D15-14. The Super-LLM 15-7 has weights that cross the dotted line 15-12 where some of the upper LLM is shared with the lower part and vis versa. The A input 15-9 has a N/2 context window while the B input 15-7 has a N/2 context window. FIG. 15C illustrates a symbol for the Super-LLM. This symbol will be useful for agentic design as will be shown shortly.

FIG. 15C illustrates a Super-LLM comprising three LLMs 15-30. The system has a regular LLM-1 15-24 which has an input prompt 15-23 and an output response 15-26. The three LLMs that make up the Super-LLM are 15-17, 15-18, and 15-19. The B context 15-22 feeds the LLM 15-19, and the output response shows up at X or output response 15-27. The C context 15-21 feeds the LLM 15-18, and the output response shows up at Y or output response 15-28. The D context 15-20 feeds the LLM 15-17, and the output response shows up at Z or output response 15-29.

FIG. 15D presents the context widow size for context windows A, B, C, and D. The context window of A is from a regular LLM. The context windows of B, C and D form the Super-LLM. The table shows that the context widow of A is independent of B, C, and D. The context window of B may be dependent on C or D, the context window of C may be dependent on C or on B or D, and the context window of D may be dependent on B or C. A symbol 15-30 illustrates the three way Super-LLM. The Super-LLM takes three prompts and generates three responses.

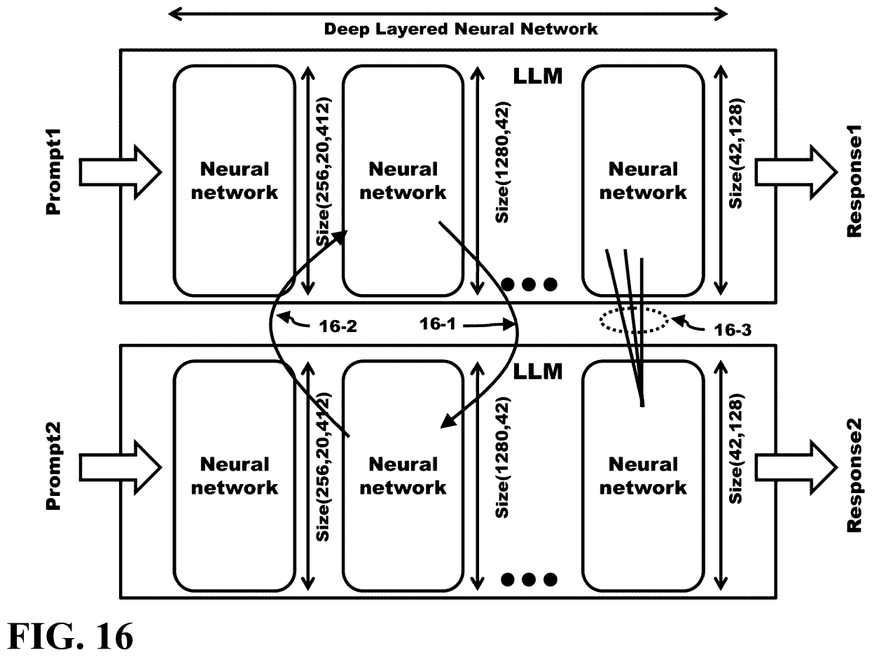

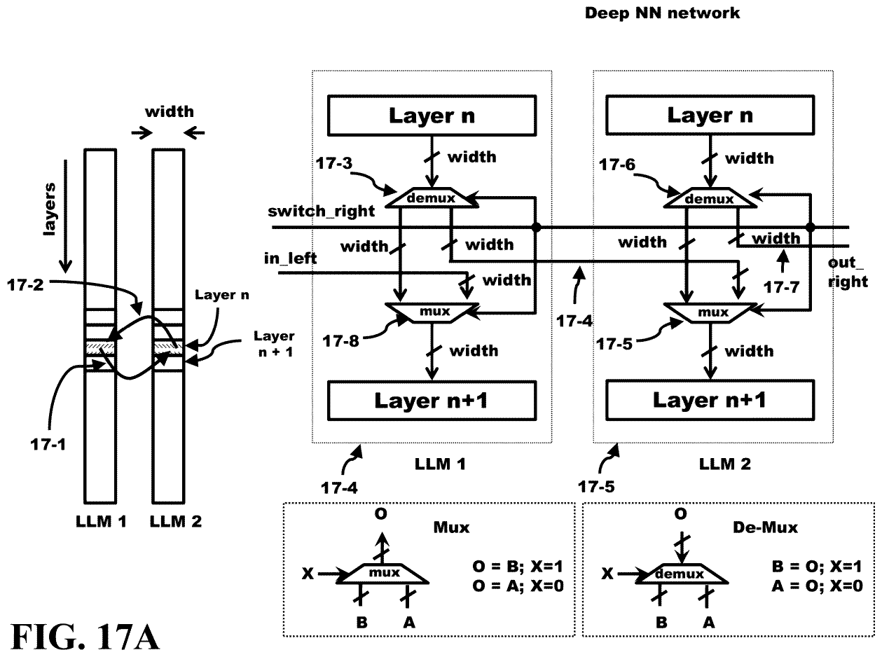

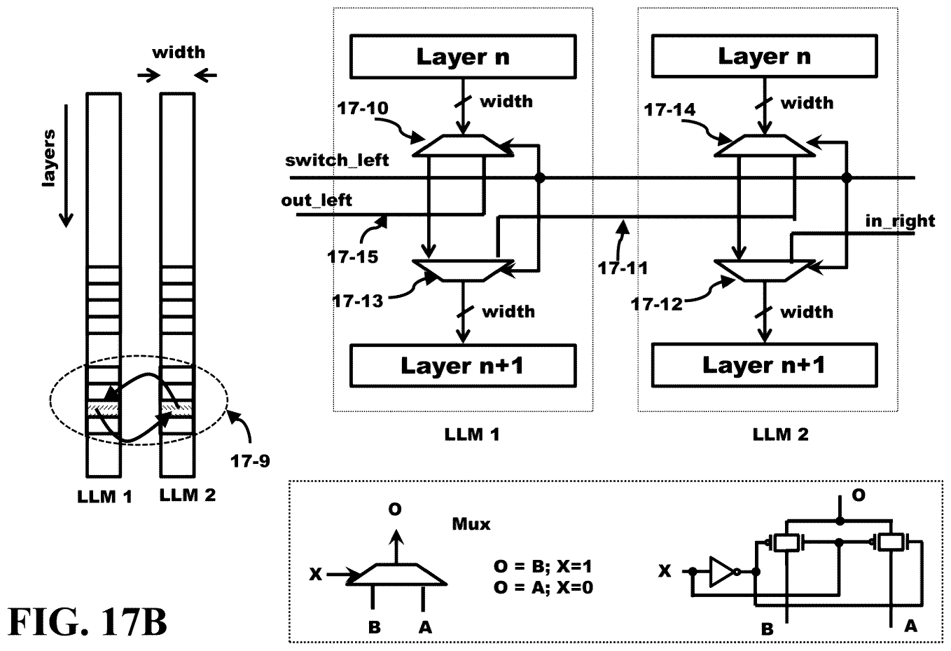

FIG. 16 depicts two LLMs where an entire neural network has been exchanged 16-1 and 16-2. In addition, a different NN provides 3 weights 16-3 to the lower NN. Due to this mixing, this is a Super-LLM.

When it is desired to switch a layer “n” between NNs in a Super-LLM to the right, a mux-like structure can be used. Suppose the dashed layers are exchanged by the process 17-1 and 17-2. This can be done by using the mux-demux structure. The mux-demux are parallel structure and they can be wide busses. From layer “n” of LLM1, the outputs would go through the demux 17-3 and with the switch-right signal enabled, the layer would move along the bus 17-4 to the mux 17-5. The mux is enabled to pass these signals to the Layer n+1 of LLM2. Simultaneously, from layer “n” of LLM2, the outputs would go through the demux 17-6 and with the switch-right signal enabled, the layer would move along the bus 17-7. The lead out_right connects to in_left and to the mux 17-8. The mux is enabled to pass these signals to the Layer n+1 of LLM1.

When it is desired to switch a layer “n” between NNs in a Super-LLM to the left, a mux-like structure can be used. Suppose the dashed layers are exchanged by the process 17-9. This can be done by using the mux-demux structure. The mux-demux are parallel structure and they can be wide busses. From layer “n” of LLM2, the outputs would go through the demux 17-14 and with the switch-left signal enabled, the layer would move along the bus 17-11 to the mux 17-13. The mux is enabled to pass these signals to the Layer n+1 of LLM1. Simultaneously, from layer “n” of LLM 1, the outputs would go through the demux 17-10 and with the switch-left signal enabled, the layer would move along the bus 17-15. The lead out_left connects to in right and to the mux 17-12. The mux is enabled to pass these signals to the Layer n+1 of LLM2. A CMOS circuit for the mux demux is illustrated in the lower right. This only shows one node. The mux-demux would be placed in parallel from as many tokens as required.

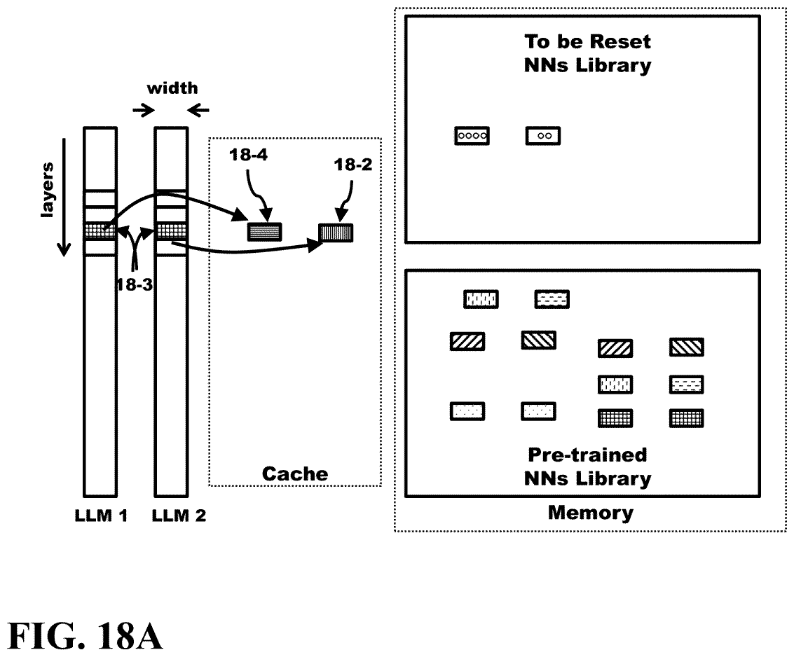

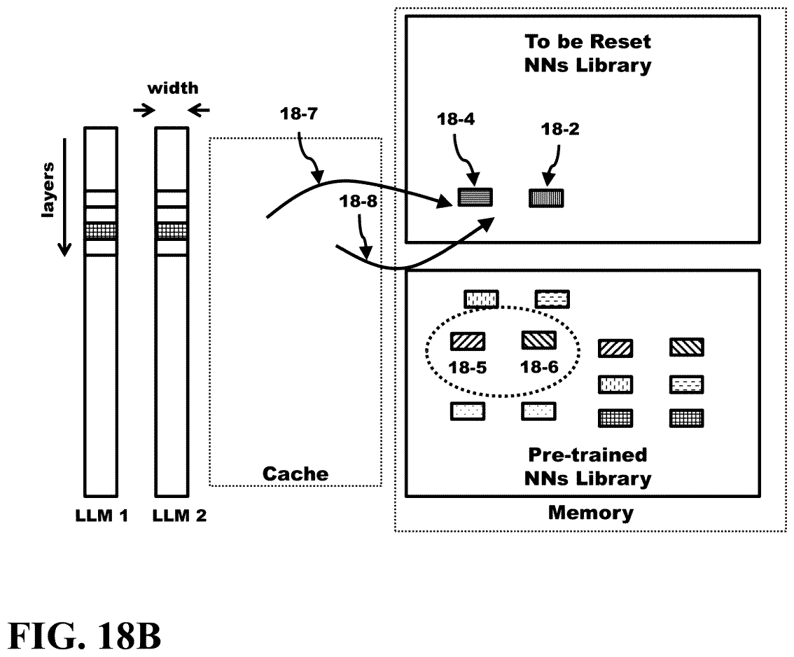

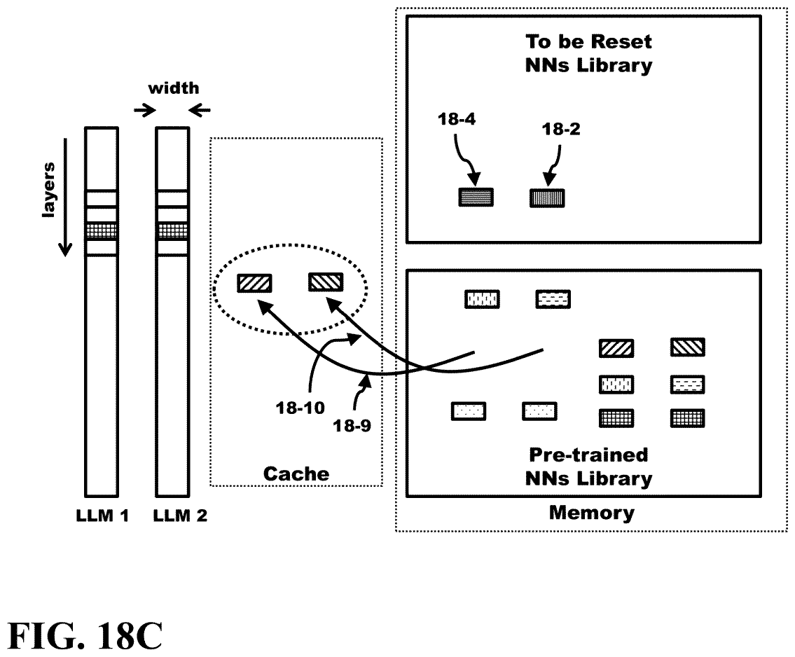

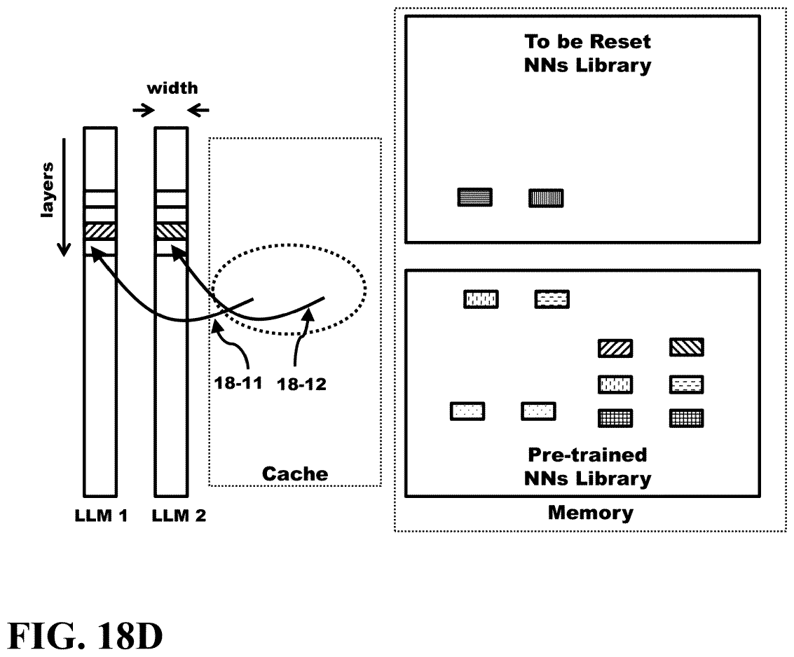

Another way of changing the layers of LLMs will be described. FIG. 18A illustrates two LLMs with one of the layers removed 18-3. The removed layers are 18-4 and 18-2 and are temporally stored in cache. Note that there is a library of pre-trained NNs, In addition, there is a library where the removed NNs will be reset. In FIG. 18B, the layers 18-4 and 18-2 are moved along paths 18-7 and 18-8, respectively, from the cache to the reset library. Simultaneously, two new layers are selected 18-5 and 18-6. FIG. 18C moves the two layers from the library to the cache vis paths 18-10 and 18-9. Finally, in FIG. 18D, the layers are moved from the cache to the LLMs. The system is ready to operate.

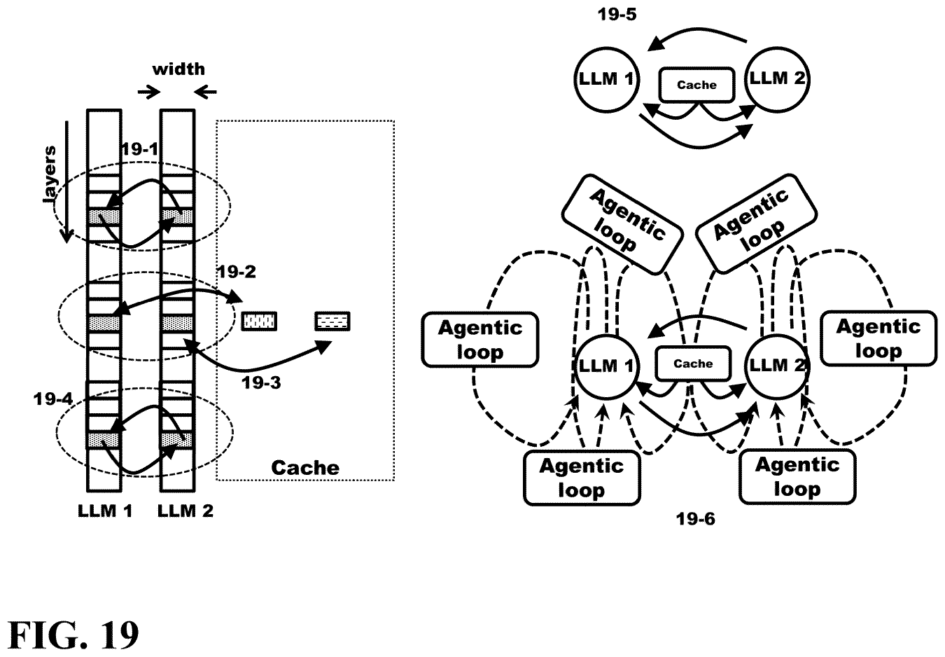

FIG. 19 illustrates two LLMs exchanging layers in 19-1 and 19-4, while 19-2 and 19-3 exchanges layers with layers in a cache. A symbol of the system is depicted in 19-5. The LLM 1 interacts with LLM 2 and with a cache. Agentic loops are added to 19-5 in 19-6.

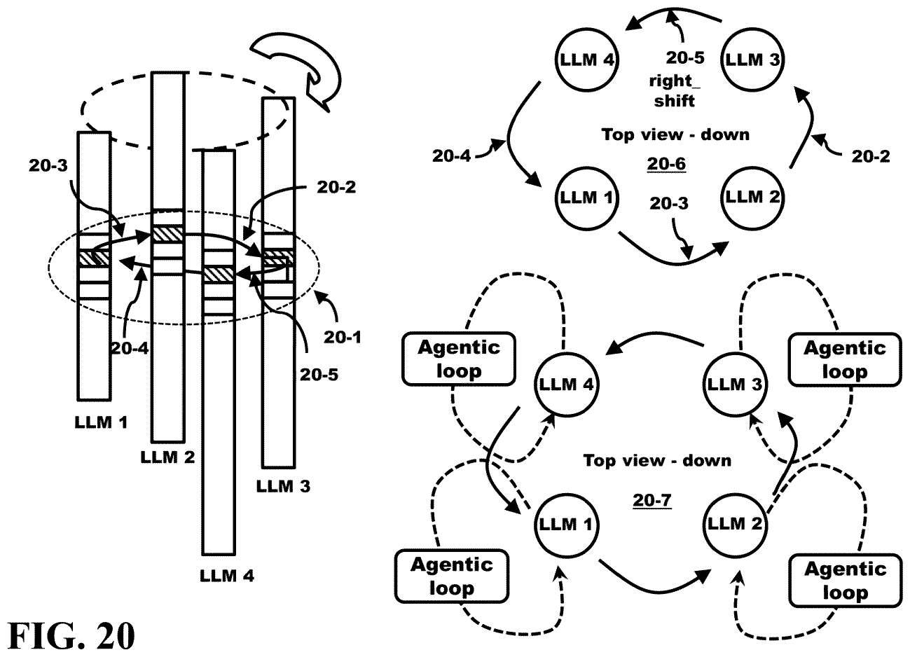

FIG. 20 depicts a right-shift event 20-1. A layer from LLM 1 transfers to LLM 2 via 20-3. A layer from LLM 2 transfers to LLM 3 via 20-2. A layer from LLM 3 transfers to LLM 4 via 20-5. And lastly, layer from LLM 4 transfers to LLM 1 via 20-4. A top down view is given in 20-6 in the upper right. Finally, in the lower right 20-7 agentic loop are tied to the LLMs.

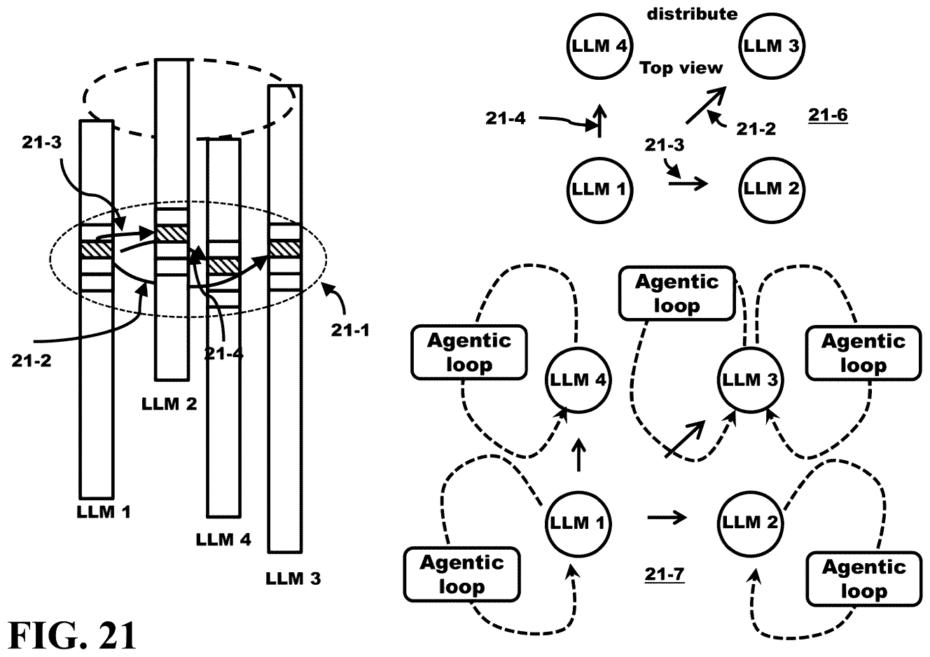

FIG. 21 depicts a one to many event 21-1. A layer from LLM 1 transfers to LLM 2 via 21-3. A layer from LLM 1 transfers to LLM 3 via 21-2. A layer from LLM 1 transfers to LLM 4 via 21-4. A top down view is given in 21-6 in the upper right. Finally, in the lower right 21-7 agentic loop are tied to the LLMs.

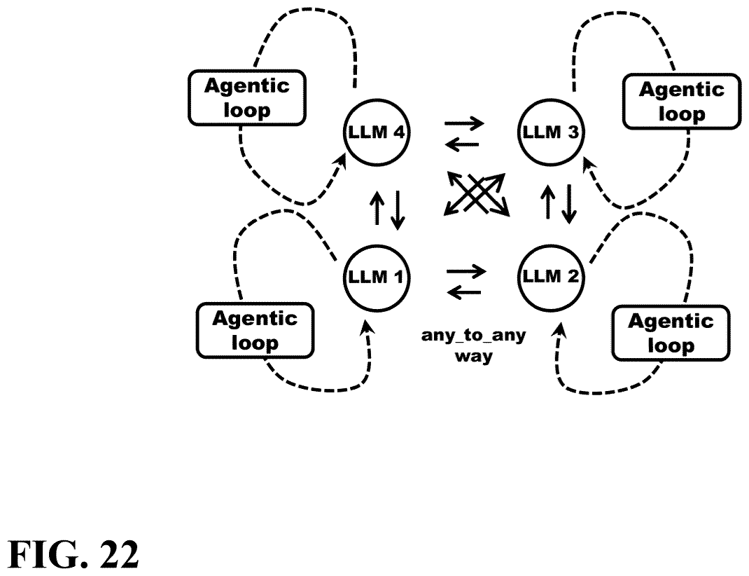

FIG. 22 illustrates a “any layer to any layer” connection using 4 LLMs. Besides switching layers, agentic loops are added to the system.

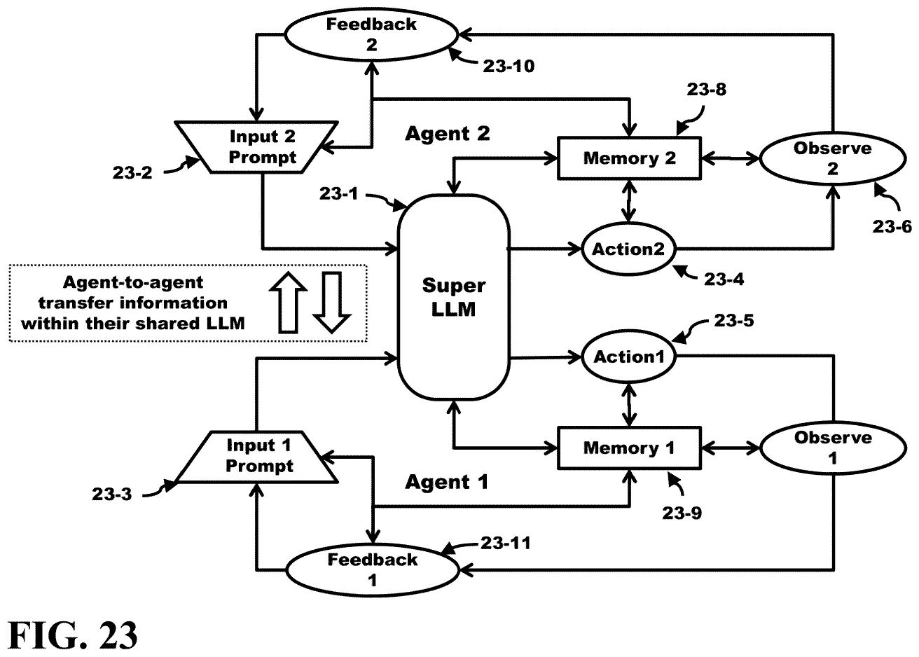

Agentic agents are constructed in FIG. 23. A Super LLM 23-1 transfers information from agent to agent within the shared LLM. The Super LLM has a first input 1 prompt 23-3 that is applied to the Super LLM and also a second input 1 prompt 23-3 that is applied to the Super LLM. The output of the Super LLM moves to an action 1 23-5 and an action 2 23-4. The Action 1 interacts with a memory 1 23-9 while action 2 interacts with a memory 2 23-8. The top loop also includes a Observe 2 23-6 while the bottom loop does not need an Observe. Feedback 1 and feedback 2 is generated and applied to the input prompt 1 and input prompt 2, respectively.

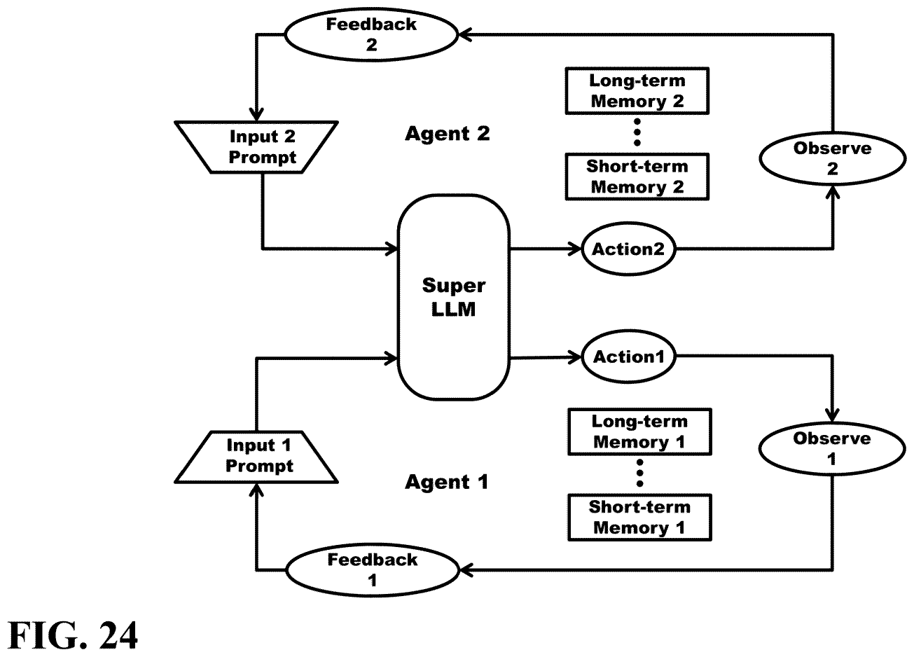

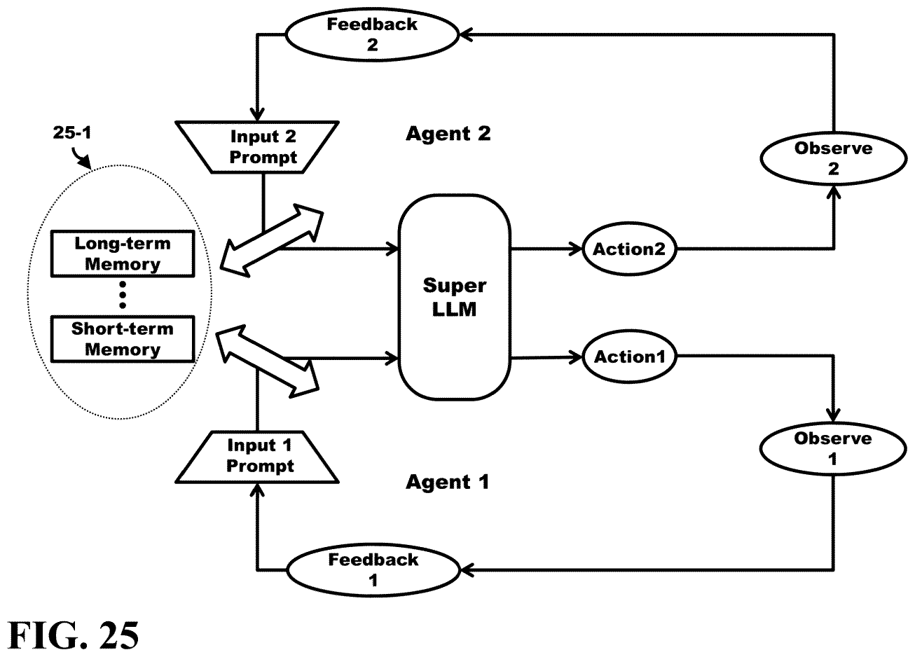

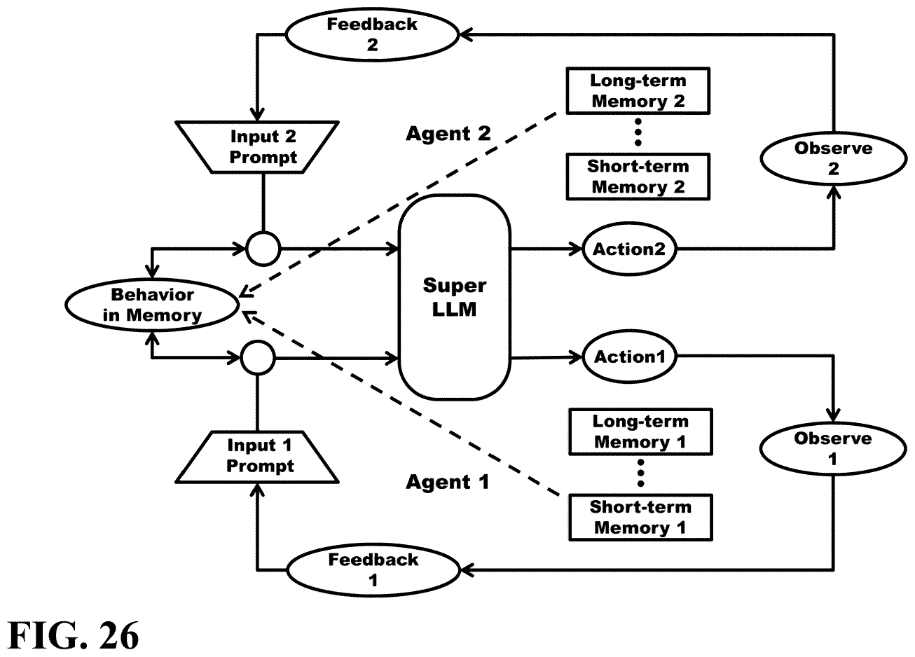

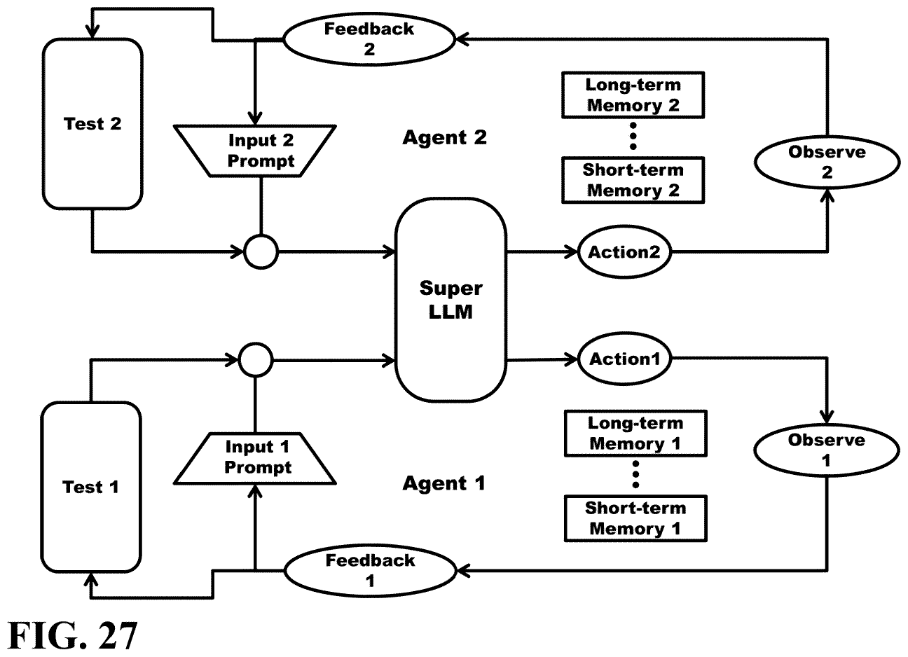

FIG. 24 replaces the memory of FIG. 23 with a long term and short term memory. Otherwise, it is a dual loop agentic system. FIG. 25 replaces the pair of a long term and short tern memories with a shared a long term and short tern memory 25-1. FIG. 26 uses the system of FIG. 24 but stores the behavior in memory. Finally, testing the agentic dual loop is illustrated in FIG. 27. Test 1 and test 2 apply inputs to Super LMM bypassing the input prompts, Finally, itis understood that the above description are only illustrative of the principles of the current disclosure. It is understood that the various embodiments of the disclosure, although different, are not mutually exclusive. In accordance with these principles, those skilled in the art may devise numerous modifications without departing from the spirit and scope of the disclosure. In one embodiment, the agents share information with other agents within the shared network between two or more LLMs. The hardware description is one way of building the NNs and LLMs. But equivalently, software can be used to construct some of these networks or a combination of firmware and software or firmware and hardware. In some designs, the NNs or LLMs are exactly equal. In other designs, the NNs or LLMs are not necessary equal. What is important is that the number of nodes in a layer can be swapped with another layer with the same number of nodes, In another embodiment, a fully connected layer of NN3 can connect to the NN4. This embodiment allows multiple agents to be formed within the neural network of the two or more LLMs. There is a similarity of the input data applied to NNs and the prompts used LLM. The input data applied to the NN has some minimum size, called a bit, while the input data applied to an LLM also has a minimum, but it is called a token. Thus, the input width would be in a number of bits for the NN, while the input width of the LLM would be in the number of tokens. Both the NN and the LLM have a finite limited input width size. Thus, for a given design of an NN and LLM, the input data width is known for both. Both get one chance to apply the input data to the input of the machine before a next request, query, data to NN, or prompt is issued. This disclosure has revealed that the same does not apply to a Super LLM; instead, the Super-LLM can accept two or more prompts, in specified input positions, which generates responses, in specified output positions, at two or more outputs, where the first prompt matches with the first output, and so on. Fabricating two NNs on a single die may shed light on the operation of neural networks by comparing the operation of the two in known initial states and comparing the mapping of the two to see if one-to one correspondence has been attained.

What is claimed is:

1. A multi-input Large Language Model (LLM) intelligent system comprising:
a first LLM, comprising:
a first input layer having a first context length, connected to a first hidden layer of a first plurality of connected hidden layers, wherein a first prompt is provided to said first input layer;
a first output layer having a first output context length, connected to a last hidden layer of said first plurality of connected hidden layers, wherein due to said first prompt, a first response is provided within said first output context length; and
a second LLM, comprising:
a second input layer having a second context length, connected to a first hidden layer of a second plurality of connected hidden layers, wherein a second prompt is provided to said second input layer;
a second output layer having a second output context length, connected to a last hidden layer of said second plurality of connected hidden layers, wherein due to said second prompt, a second response is provided within said second output context length, wherein
an output from said first input layer or said one of said first plurality of connected hidden layers of said first LLM is applied as an input to a corresponding next layer of said second LLM.

2. The system of claim 1, wherein
an output from said second input layer or said one of said second plurality of connected hidden layers of said second LLM is applied as an input to a corresponding next layer of said first LLM.

3. The system of claim 1, wherein
all outputs from said first input layer or said all outputs of at least one of said first plurality of connected hidden layers of said first LLM are applied as an input to a corresponding next layer of said second LLM.

4. The system of claim 1, wherein
all outputs from said second input layer or said all outputs of at least one of said second plurality of connected hidden layers of said second LLM are applied as an input to a corresponding next layer of said first LLM.

5. The system of claim 1, wherein
all convolutional outputs from said first input layer or said all convolutional outputs of at least one of said first plurality of connected hidden layers of said first LLM are applied as an input to a corresponding next layer of said second LLM.

6. The system of claim 1, wherein
all convolutional outputs from said second input layer or said all convolutional outputs of at least one of said second plurality of connected hidden layers of said second LLM are applied as an input to a corresponding next layer of said first LLM.

7. The system of claim 1, wherein
at least a same portion said first LLM and said second LLM can be fabricated on a single integrated CMOS circuit chip.

8. A multi-input LLM intelligent system comprising:
a first LLM, comprising:
a first input layer having a first context length, connected to a first hidden layer of a first plurality of connected hidden layers, wherein a first prompt is provided to said first input layer;
a first output layer having a first output context length, connected to a last hidden layer of said first plurality of connected hidden layers, wherein due to said first prompt, a first response is provided within said first output context length; and
a second LLM, comprising:
a second input layer having a second context length, connected to a first hidden layer of a second plurality of connected hidden layers, wherein a second prompt is provided to said second input layer;
a second output layer having a second output context length, connected to a last hidden layer of said second plurality of connected hidden layers, wherein due to said second prompt, a second response is provided within said second output context length, wherein
an output from said first input layer or said one of said first plurality of connected hidden layers of said first LLM is applied as an input to a corresponding next layer of said second LLM, and wherein
an output from said second input layer or said one of said second plurality of connected hidden layers of said second LLM is applied as an input to a corresponding next layer of said first LLM.

9. The system of claim 8, wherein
all outputs from said first input layer or said all outputs of at least one of said first plurality of connected hidden layers of said first LLM are applied as an input to a corresponding next layer of said second LLM.

10. The system of claim 8, wherein
all outputs from said second input layer or said all outputs of at least one of said second plurality of connected hidden layers of said second LLM are applied as an input to a corresponding next layer of said first LLM.

11. The system of claim 8, wherein
all convolutional outputs from said first input layer or said all convolutional outputs of at least one of said first plurality of connected hidden layers of said first LLM are applied as an input to a corresponding next layer of said second LLM.

12. The system of claim 8, wherein
all convolutional outputs from said second input layer or said all convolutional outputs of at least one of said second plurality of connected hidden layers of said second LLM are applied as an input to a corresponding next layer of said first LLM.

13. The system of claim 8, wherein
at least a same portion said first LLM and said second LLM can be fabricated on a single integrated CMOS circuit chip.

14. A multi-input LLM intelligent system comprising:
a first LLM, comprising:
a first input layer having a first context length, connected to a first hidden layer of a first plurality of connected hidden layers, wherein a first prompt is provided to said first input layer;
a first output layer having a first output context length, connected to a last hidden layer of said first plurality of connected hidden layers, wherein due to said first prompt, a first response is provided within said first output context length; and
a second LLM, comprising:
a second input layer having a second context length, connected to a first hidden layer of a second plurality of connected hidden layers, wherein a second prompt is provided to said second input layer;
a second output layer having a second output context length, connected to a last hidden layer of said second plurality of connected hidden layers, wherein due to said second prompt, a second response is provided within said second output context length, wherein
all outputs from said first input layer or said all outputs of at least one of said first plurality of connected hidden layers of said first LLM are applied as an input to a corresponding next layer of said second LLM.

15. The system of claim 14, wherein
all outputs from said second input layer or said all outputs of at least one of said second plurality of connected hidden layers of said second LLM are applied as an input to a corresponding next layer of said first LLM.

16. The system of claim 14, wherein
said LLMs are identical.

17. The system of claim 14, wherein
said LLMs have previously been handled and trained identically with identical prompts and all types of testing and initializing.

18. The system of claim 14, wherein
at least a same portion said first LLM and said second LLM can be fabricated on a single integrated CMOS circuit chip.

19. The system of claim 14, wherein
a total width of an input context size of said system is equal to a summation of widths of said first input layer and said second input layer.

20. The system of claim 14, wherein
a total width of an output context size of said system is equal to a summation of widths of said first output context length and said second output context length.
